(19) United States
(12) Patent Application Publication
(10) Pub. No.: US 2021/0232805 A1
(43) Pub. Date: Jul. 29, 2021

(54) SYSTEM FOR MANAGING EXPLORATION AND CONSUMPTION OF DIGITAL CONTENT IN CONNECTION WITH A PHYSICAL ARTICLE

(71) Applicant: Jostens, Inc., Minneapolis, MN (US)

(72) Inventors: Ann Merz Carr, Hopkins, MN (US); Michael Wolf, Apple Valley, MN (US); Charles Stuart-King, Richmond, VA (US); Gavin Buerk, Richmond, VA (US); Zachary Bruno, Richmond, VA (US)

(21) Appl. No.: 17/118,812

(22) Filed: Dec. 11, 2020

Related U.S. Application Data
(60) Provisional application No. 62/965,408, filed on Jan. 24, 2020.

(51) Int. Cl. G06K 9/00; G06F 16/535; G06F 16/51; G06F 16/538; G06N 20/00; G06Q 10/10

(52) U.S. Cl. CPC G06K 9/00281; G06K 9/00228; G06F 16/535; G06Q 10/107; G06F 16/538; G06N 20/00; G06F 16/51

(57) ABSTRACT

The invention generally relates to managing and sharing digital content, and, more particularly, to a web- or cloud-based platform providing for the contribution, management, and subsequent exploration and consumption of digital content in connection with printed content provided in a physical article, such as a yearbook or other memorabilia.

### CROSS-REFERENCE TO RELATED APPLICATION

This application claims priority to, and the benefit of, U.S. Provisional Application No. 62/965,408, filed on Jan. 24, 2020, the content of which is incorporated by reference herein in its entirety.

### FIELD OF THE INVENTION

The invention relates to a web- and/or cloud-based platform providing for the contribution, management, and subsequent exploration and consumption of digital content in connection with printed content provided in a physical article, such as a yearbook or other memorabilia.

### BACKGROUND

Each year, many educational institutions, including most secondary schools and universities, prepare yearbooks memorializing the school year's events. A yearbook includes collections of related photographs, graphics, and descriptions commemorating school activities and accomplishments over a given year.

The conventional yearbook consists of a published book, including printed photographs of each student (student portraits), school staff, as well as printed photographs and descriptions of school events and activities (i.e., student athletics, clubs, and activities, as well as school events). While the conventional yearbook has been a mainstay for many years, advancing technology has inevitably led to providing yearbooks in a digital format in an effort to replace the printed yearbook. It is clear that there are certainly advantages of providing a digital yearbook over a physical, printed yearbook. For example, users are able to view yearbook content at their leisure and from a variety of computing devices, most notably personal smartphones or tablets, thereby making the yearbook readily available and much more accessible than a printed yearbook. Furthermore, content (i.e., photos, descriptions, graphics, etc.) can be added, removed, or updated on the fly, as opposed to printed yearbooks, in which the content is static in nature.

While digital yearbooks may provide some obvious advantages over their conventional, printed counterpart, there are some drawbacks. For example, many people enjoy the experience that comes with a physical book, such as the feel of the book (i.e., holding the book, turning the pages, and the feel of the paper). A digital yearbook is unable to provide such an experience. Furthermore, printed content may be easier on one's eyes, as there is little to no eye strain that may be experience when viewing content on a display of a computing device.

### SUMMARY

The present invention is directed to an interactive yearbook. The interactive yearbook is provided in printed form and includes printed content (i.e., printed images, graphics, descriptions, and the like), thereby resembling a conventional printed yearbook. However, the interactive yearbook is further associated with a web- and/or cloud-based platform including an interface with which one or more users can interact (via a computing device) for the contribution, management, and subsequent exploration and consumption of digital content in connection the printed content provided in the interactive yearbook. Accordingly, the interactive yearbook of the present invention provides a user with the advantages associated with each of a printed yearbook and digital yearbook format. More specifically, not only can a user hold a physical book and experience the feel of turning physical pages and seeing printed content, but the user can further access additional digital content that further expands upon related printed content, providing a more enhanced and overall interactive experience for the user.

The platform, for example, is accessible to users via a wide range of computing devices, such as personal computers (PCs), laptops, smartphones, tablets, or other mobile computing devices. The users may include, for example, students and staff of an educational institution (i.e., a school), as well as other users who may include friends and/or family of the students, or other individuals viewing the printed yearbook.

The platform allows for certain users, such as the students, to contribute digital content (i.e., digital images, videos, audio files, text, etc.) associated with specific printed content. For example, upon registering with the platform and further passing an authentication process to establish their identity, a student is given the option to supplement certain printed content in the yearbook with digital content of their choosing, which will be available, via the platform, for other users to view. The printed content in the yearbook may include, for example, a portrait photograph of the given student that will be printed in the yearbook. The printed content in the yearbook may also be related to certain school life topics, such as athletics, organizations, clubs, activities, and school events. The platform allows for the student to select digital content of their choice to be associated with specific printed content. In one instance, a student may contribute (i.e., upload) a set of digital images (from their mobile device, for example) to the platform to be associated with specific printed content, such as their portrait photograph. The contributed digital content undergoes a content moderation process to ensure that the digital content is in compliance with policies instituted by the school (or other governing body).

If any of the digital content is not in compliance, such digital content is rejected (i.e., the digital content is made inaccessible by other users and is thus not available for viewing by other users via the platform). In some embodiments, the student may further be alerted that certain digital content was rejected, thereby allowing them to take further action, such as choosing other digital content to be submitted. If, however, the contributed digital content is found to be in compliance with the policies, such digital content is stored within a database associated with the platform and further tied to the particular printed content (i.e., the student's portrait photograph) via a unique identifier, for example.

The platform allows for users to explore and consume (i.e., access, including view or hear) user-contributed digital content. In order to gain access to the platform for subsequent exploration of user-contributed digital content, the user must first complete an onboarding process. Such a process involves the user utilizing a personal computing device, such as a tablet or smartphone, having image scanning and/or capturing capabilities (i.e., a camera) in order to capture data associated with a machine readable label printed in the physical yearbook. For example, the yearbook may include a QR code or other machine readable label that, once captured via a camera of the user's smartphone or tablet, results in the user gaining access to the platform.

Upon accessing the platform (which may be running as a web-based app or running as a local, mobile-based app), the user is then prompted to use a viewfinder (associated with the app) shown on a display of their smartphone or tablet to scan over printed content in the yearbook. The printed content may include, for example, student portrait photographs or printed content associated with school life topics. Once printed content of interest is within the field of the viewfinder, the user need only capture an image (via their device's camera) of the printed content. Upon capturing image data associated with the printed content, such as a specific student's portrait photograph, the platform is able to determine whether such printed content includes associated user-contributed digital content for viewing. If there is no digital content available (i.e., the student of that particular portrait has not yet contributed and digital content for their portrait photograph), the platform provides the user with a message indicating so. If, however, user-contributed digital content is available, the user is then provided with access to viewing such content.

The platform further provides some users with management capabilities. For example, certain users may include staff associated with the yearbook and tasked with the creation and/or management of the yearbook. Such staff may include employees of the educational institution and/or representatives of the company providing the yearbook and associated platform. Accordingly, such users may be provided with administrative capabilities, such as managing users and the contribution of digital content therefrom (i.e., providing content moderation, determining which printed content will be available for digital content to be tied thereto, determining the amount of allowed digital content for any given printed content, etc.), managing the design and layout of both the printed content in the yearbook and the digital content to be presented via the platform, managing access to such digital content, as well as managing the administrative capabilities of other users.

By combining user-contributed digital content and the traditional print yearbook, the present invention provides an interactive and inclusive experience, empowering every student to represent who they are. Allowing for student-selected content provides a customized feel and offers students the opportunity to share their own personal stories and memories via the digital images that they select. Furthermore, the present invention drives coverage within yearbook, as any given student can supplement printed content with additional digital content, thereby expanding the available content. Additionally, the web- and/or cloud-based platform is accessible via a user's personal computing device, such as a smartphone or tablet, and does not require any downloads or specialized hardware to in order to experience the offerings of the interactive yearbook. Additionally, all submitted digital content is moderated to ensure appropriateness and compliance with policies.

In one aspect, the invention provides a system providing for the contribution, management, and subsequent exploration and consumption of digital content in connection with printed content provided in a physical article. The system includes a server configured to communicate and exchange data with one or more computing devices over a network. The server includes a hardware processor coupled to non-transitory, computer-readable memory containing instructions executable by the processor to cause the server to store, in a database, a plurality of user accounts, each user account comprises user-contributed digital content associated with respective printed content provided in a physical article, the user-contributed digital content having successfully undergone a content moderation process. The server is further configured to receive, from a computing device, a request for access to user-contributed digital content of one of the user accounts, the request comprising image data captured via a camera of the computing device, the image data including one or more unique identifiers associated with printed content in the physical article. Upon receipt of the request, the server is configured to process the request to identify a user account and user-contributed digital content associated with the printed content in the physical article and subsequently provide the requesting computing device with access to the user-contributed digital content upon a positive identification.

The server may generally provide a web- and/or cloud-based platform including an interface with which one or more users can interact (via a computing device) for the contribution, management, and subsequent exploration and consumption of digital content in connection the printed content provided in the interactive yearbook.

The physical article may include a yearbook associated with an education institution (i.e., a school) and users may include at least one of students of the educational institution, friends and/or relatives associated with a student, staff associated with the yearbook and tasked with creation and/or management thereof, and staff or employees of the educational institution.

In some embodiments, the content moderation process may include at least one of an artificial intelligence (AI)-based content moderation process and a human-based content moderation process. For example, in some embodiments, the user-contributed digital content may initially undergo the AI-based content moderation process and then subsequently undergo the human-based content moderation process. Each of the AI-based and human-based content moderation processes comprises review of user-contributed digital content and a determination of whether subject matter of the user-contributed digital content complies with policies instituted by the educational institution governing the sharing of such content. User-contributed digital content is deemed to have successfully undergone a content moderation process upon a positive determination that the subject matter of the user-contributed digital content complies with the policies.

In some embodiments, each user account is associated with a respective student of the educational institution. Prior to receiving, accepting, and storing user-contributed digital content, the server is configured to initiate at least one of an initial registration process and an authentication process with a given student. For example, an initial registration process may include transmitting, from the server, an invitation to a given student to contribute digital content associated with the yearbook. The invitation may prompt the student to confirm acceptance of the invitation. For example, a given educational institution may provide a list of enrolled students, including respective email addresses of each, to be stored within a user database associated with the platform. The initial registration process may consist of a user (a student) providing their email address, wherein the student-submitted email address is simply checked against stored list of valid and authentic email addresses. Upon establishing a successful match, the student is then provided (via email) with a unique code, which is used for completing the registration and authentication process, at which point the student may access the platform and begin contributing and exploring digital content.

It should be noted that other methods of registration and authentication may be implemented with the systems of the present invention. For example, the system of the present invention may utilize a single sign-on authentication scheme, particularly in conjunction with education-related or learning management platforms, such as Canvas and Blackboard, for example.

Yet still, in additional embodiments, the authentication process may include transmitting a request to the given student to confirm their identity by satisfying at least one of a biometric factor and a challenge-response factor. The biometric factor may include at least one of a fingerprint scan, a retinal scan, a facial scan, voice recognition, and speech recognition. The challenge-response factor may include at least one of password authentication, passphrase authentication, and email authentication, for example. In some embodiments, the server may be configured to carry out at least one of facial-recognition analysis and keypoint detection analysis to confirm an identity of a given student during an authentication process.

The printed content may generally include at least one of an image and text provided in the yearbook. For example, the printed content may include a portrait photograph of a given student. In some embodiments, the printed content may be related to certain school life topics, such as athletics, organizations, clubs, activities, and school events. The user-contributed digital content may generally include at least one of one or more images, one or more video-based files, one or more audio-based files, and text. Accordingly, in some embodiments, the printed content is a portrait photograph of a given student and the corresponding user account for the given student includes a set of one or more digital photographs contributed by the given student and associated with the portrait photograph in the yearbook.

The request for access to user-contributed digital content may include a captured image of a portrait photograph of a student from the yearbook. The processing of the request may include performing image analysis on the captured image of the portrait photograph to identify one or more unique identifiers associated with the portrait photograph and further correlating the one or more unique identifiers with identifying data associated with the set of one or more student-contributed digital photographs of the student's account. At least one set of one or more student-contributed digital photographs for each student account is tied to a corresponding portrait photograph of that student via a unique identifier. The image analysis includes at least one of facial recognition analysis and keypoint detection analysis. Accordingly, in some embodiments, the one or more unique identifiers includes one or more keypoints. Upon a positive correlation, the server is configured to provide the requesting computing device with access to the set of one or more student-contributed digital photographs.

### BRIEF DESCRIPTION OF THE DRAWINGS

FIG. 1 is a block diagram illustrating one embodiment of an exemplary system for managing digital content, including exploration and consumption of such content, in connection with a physical article.

FIG. 2 is a block diagram illustrating the digital content management platform of FIG. 1 in greater detail.

FIG. 3 is a block diagram illustrating the various databases in greater detail.

FIG. 4 is a block diagram illustrating a student communicating with the digital content management platform (via a computing device) and completing an initial registration process and establishing their identity via an authentication process prior to contributing student-selected digital content.

FIG. 5 is a block diagram illustrating communication and exchange of data between the student (via their computing device) and the digital content management platform, including the contribution of student-selected digital content to be tied to respective printed content of a yearbook.

FIG. 6 is a block diagram illustrating the user-contributed digital content undergoing a content moderation process (AI-based and/or human-based content moderation) to determine whether the digital content complies with policies governing the appropriateness of digital content to be stored and subsequently accessed for viewing.

FIG. 7 is a block diagram illustrating the association of one or more sets of user-contributed digital content to separate respective printed content from the yearbook via a unique identifier.

FIG. 8 is a block diagram illustrating an administrator communicating with the digital content management platform (via a computing device) and managing digital content, as well as managing users, via a variety of management and customization features.

FIG. 9 is a block diagram illustrating a user communicating with the digital content management platform (via a personal computing device, such as a smartphone or tablet) and completing an initial onboarding process in order to access the platform and subsequently gain access to and explore user-contributed digital content.

FIG. 10 is a block diagram illustrating a user requesting access to user-contributed digital content by transmitting, to the digital content management platform, image data associated with printed content in a yearbook, the image data captured via a camera of the user's computing device.

FIG. 11 shows and exemplary smartphone utilizing an integrated camera to scan over printed content in the yearbook and subsequently capturing image data associated with the printed content, such as a specific student's portrait photograph.

FIG. 12 is a block diagram illustrating processing of the request (i.e., processing of the image data) to identify user-contributed digital content associated with the printed content and subsequent granting of access to and exploration of the identified user-contributed digital content.

FIG. 13 is a block diagram illustrating at least one embodiment of a computing device (i.e., smartphone or tablet) for communicating with the digital content management platform and allowing an associated user to interact with the platform to at least contribute selected digital content and/or access and explore user-contributed digital content.

FIG. 14 is an exemplary invitation provided to a user (i.e., student) to join (i.e., register with the digital content management platform) and subsequently contribute selected digital content to correspond with specific printed content the student's yearbook.

FIG. 15 is a screenshot of an interface display on a mobile device of a user associated with the yearbook services provided by the digital content management platform. The interface illustrates a landing page in which the user is invited to contribute their own photos for specific printed content (i.e., that student's portrait photograph or school life topics).

FIG. 16 is a screenshot of an interface displayed on the user's mobile device illustrating an authentication request.

FIGS. 17A, 17B, 17C, and 17D are screenshots of an interface displayed on the user's mobile device illustrating a user's ability to contribute (i.e., select and arrange) a set of their own digital photos to be associated with their student portrait photograph to be printed in the yearbook.

FIGS. 18A, 18B, 18C, 18D, 18E, and 18F are screenshots of an interface displayed on the user's mobile device illustrating a user's ability to contribute (i.e., select and arrange) a set of their own digital photos to be associated with a specific selected school life topic to be printed in the yearbook.

FIGS. 19A, 19B, 19C, 19D, 19E, 19F, 19G, 19H, and 19I are images illustrating the specific steps taken by a user in order to interact with the digital content management platform and request access to user-contributed digital content associated with printed content in the yearbook.

FIGS. 20, 21, 22A, 22B, 23A, 23B, 23C, 24A, 24B, 25A, and 25B are screenshots of an interface displayed on a user's computing device providing the user with various management features, including managing users and the contribution of digital content therefrom (i.e., providing content moderation, determining which printed content will be available for digital content to be tied thereto, determining the amount of allowed digital content for any given printed content, etc.), managing the design and layout of both the printed content in the yearbook and the digital content to be presented via the platform, managing access to such digital content, as well as managing the administrative capabilities of other users.

### DETAILED DESCRIPTION

The present invention is directed to a web- and/or cloud-based platform providing for the contribution, management, and subsequent exploration and consumption of digital content in connection with printed content provided in a physical article, such as a yearbook or other memorabilia. In particular, the present invention is directed to an interactive yearbook, provided in printed form and associated with a platform with which one or more users can interact for the contribution, management, exploration and consumption of digital content in connection the printed content provided in the interactive yearbook.

The platform, for example, is accessible to users via a wide range of computing devices, such as personal computers (PCs), laptops, smartphones, tablets, or other mobile computing devices. The users may include, for example, students and staff of an educational institution (i.e., a school), as well as other users who may include friends and/or family of the students, or other individuals viewing the printed yearbook.

The platform allows for certain users, such as the students, to contribute digital content (i.e., digital images, videos, audio files, text, etc.) associated with specific printed content. For example, upon registering with the platform and further passing an authentication process to establish their identity, a student is given the option to supplement certain printed content in the yearbook with digital content of their choosing, which will be available, via the platform, for other users to view. The printed content in the yearbook may include, for example, a portrait photograph of the given student that will be printed in the yearbook. The printed content in the yearbook may also be related to certain school life topics, such as athletics, organizations, clubs, activities, and school events. The platform allows for the student to select digital content of their choice to be associated with specific printed content. In one instance, a student may contribute (i.e., upload) a set of digital images (from their mobile device, for example) to the platform to be associated with specific printed content, such as their portrait photograph. The contributed digital content undergoes a content moderation process to ensure that the digital content is in compliance with policies instituted by the school (or other governing body). If any of the digital content is not in compliance, such digital content is flagged and the student is alerted. If, however, the contributed digital content is found to be in compliance with the policies, such digital content is stored within a database associated with the platform and further tied to the particular printed content (i.e., the student's portrait photograph) via a unique identifier, for example.

The platform allows for users to explore and consume user-contributed digital content. In order to gain access to the platform for subsequent exploration of user-contributed digital content, the user must first complete an onboarding process. Such a process involves the user utilizing a personal computing device, such as a tablet or smartphone, having image scanning and/or capturing capabilities (i.e., a camera) in order to capture data associated with a machine readable label printed in the physical yearbook. For example, the yearbook may include a QR code or other machine readable label that, once captured via a camera of the user's smartphone or tablet, results in the user gaining access to the platform. The user is then prompted to use their camera to scan over printed content in the yearbook, which may include student portrait photographs or printed content associated with school life topics. Upon capturing image data associated with the printed content, such as a specific student's portrait photograph, the platform is able to determine whether such printed content includes associated user-contributed digital content for viewing. If there is no digital content available (i.e., the student of that particular portrait has not yet contributed and digital content for their portrait photograph), the platform provides the user with a message indicating so. If, however, user-contributed digital content is available, the user is then provided with access to viewing such content.

The platform further provides some users with management capabilities. For example, certain users may include staff associated with the yearbook and tasked with the creation and/or management of the yearbook. Such staff may include employees of the educational institution and/or representatives of the company providing the yearbook and associated platform. Accordingly, such users may be provided with administrative capabilities, such as managing users and the contribution of digital content therefrom (i.e., providing content moderation, determining which printed content will be available for digital content to be tied thereto, determining the amount of allowed digital content for any given printed content, etc.), managing the design and layout of both the printed content in the yearbook and the digital content to be presented via the platform, managing access to such digital content, as well as managing the administrative capabilities of other users.

Accordingly, the interactive yearbook of the present invention provides a user with the advantages associated with each of a printed yearbook and digital yearbook format. More specifically, not only can a user hold a physical book and experience the feel of turning physical pages and seeing printed content, but the user can further access additional digital content that further expands upon related printed content, providing a more enhanced and overall interactive experience for the user. By combining user-contributed digital content and the traditional print yearbook, the present invention provides an interactive and inclusive experience, empowering every student to represent who they are. Allowing for student-selected content provides a customized feel and offers students the opportunity to share their own personal stories and memories via the digital images that they select. Furthermore, the present invention drives coverage within yearbook, as any given student can supplement printed content with additional digital content, thereby expanding the available content. Additionally, the web- and/or cloud-based platform is accessible via a user's personal computing device, such as a smartphone or tablet, and does not require any downloads or specialized hardware to in order to experience the offerings of the interactive yearbook. Additionally, all submitted digital content is moderated to ensure appropriateness and compliance with policies.

It should be noted that, while the following description is focused on yearbooks, particularly for educational institutions, the systems and methods described herein can be used for any physical article or publication similar to, or resembling, a yearbook, which includes a collection of photographs, descriptions, and stories or the like, and is not limited to educational institutions. For example, the systems and methods described herein can be used with publications associated with the military or for companies.

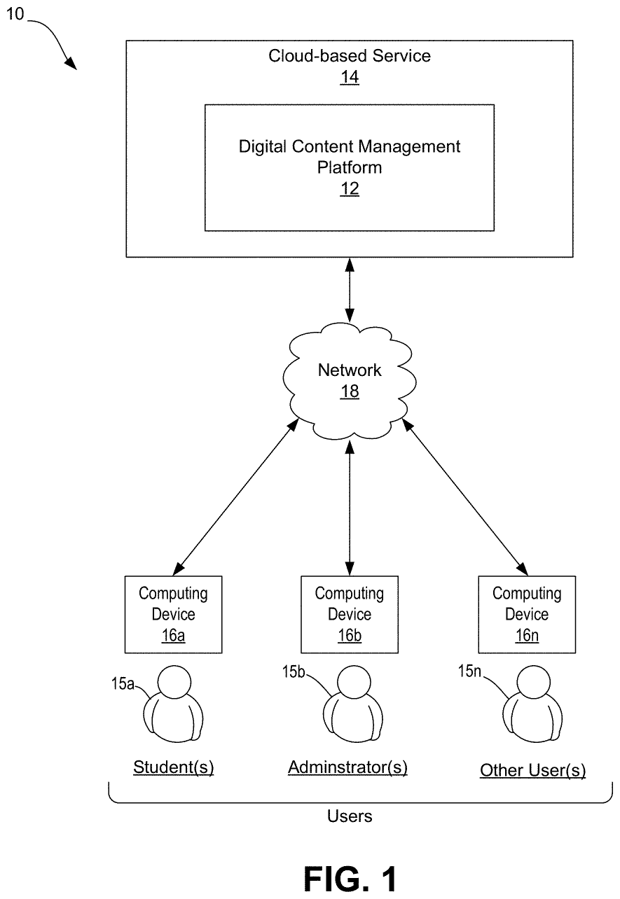

FIG. 1 illustrates one embodiment of an exemplary system 10 consistent with the present disclosure. As shown, system 10 includes a digital content platform 12 embodied on an internet-based computing system/service. For example, as shown, the digital content management platform 12 may be embodied on a cloud-based service 14, for example. The digital content management platform 12 is configured to communicate and share data with one or more users 15(a)-15(n) via computing devices 16(a)-16(n) over a network 18, for example. In the present context, at least some of the users include students of an educational institution (i.e., a school) (i.e., student(s) 15a), while other users may include administrator(s) 15b, which may include, for example, staff associated with the yearbook and tasked with the creation and/or management of the yearbook. Such staff may include employees of the educational institution and/or representatives of the company providing the yearbook and associated platform. Yet still, at least some of the users include other individuals (i.e., other user(s) 15n) that may be associated with a given student (i.e., friends, relatives, acquaintance) or may otherwise just be viewing a yearbook, as will be described in greater detail herein.

The network 18 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the computing devices 16 and/or between the computing devices 16 and the cloud-based service 14, may be, in whole or in part, a wired connection.

The network 18 may be any network that carries data. Non-limiting examples of suitable networks that may be used as network 18 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), the most recently published versions of IEEE 802.11 transmission protocol standards, other networks capable of carrying data, and combinations thereof. In some embodiments, network 18 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

The digital content management platform 12 is configured to communicate and share data with the computing devices 16 associated with one or more users 15. Accordingly, the computing device 16 may be embodied as any type of device for communicating with the digital content management platform 12 and cloud-based service 14, and/or other user devices over the network 18. For example, at least one of the user devices may be embodied as, without limitation, a computer, a desktop computer, a personal computer (PC), a tablet computer, a laptop computer, a notebook computer, a mobile computing device, a smartphone, a cellular telephone, a handset, a messaging device, a work station, a distributed computing system, a multiprocessor system, a processor-based system, and/or any other computing device configured to store and access data, and/or to execute software and related applications consistent with the present disclosure.

In the embodiments described here, the device 16a associated with at least the student 15a is generally embodied as a smartphone or tablet, the device 16n associated with the other user(s) is also generally embodiments as a smartphone or tablet, while the devices 16b associated with the administrator(s) 15b, may generally be embodied as an computing device, including a personal computer (PC), laptop, smartphone, tablet, as well as any one of the other computing devices previously listed herein.

The digital content management platform 12 provides yearbook-related services, particularly for providing digital content that complements and expands upon associated printed content contained in a physical yearbook. In particular, the yearbook associated with the platform 12 is an interactive yearbook, provided in printed form and includes printed content (i.e., printed images, graphics, descriptions, and the like), thereby resembling a conventional printed yearbook. However, the interactive yearbook is further associated with the platform 12 with which one or more users can interact for the contribution, management, and exploration and consumption of digital content in connection the printed content provided in the interactive yearbook, as will be described in greater detail herein.

It should be noted that embodiments of the system 10 of the present disclosure include computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

It should be noted that the yearbook services provided by the platform 12 are flexible and can be customized to fit any entity's culture and needs. For example, the yearbook services provided via the platform 12 may be implemented via the cloud-based service, including, for example, a software as a service (SaaS) model.

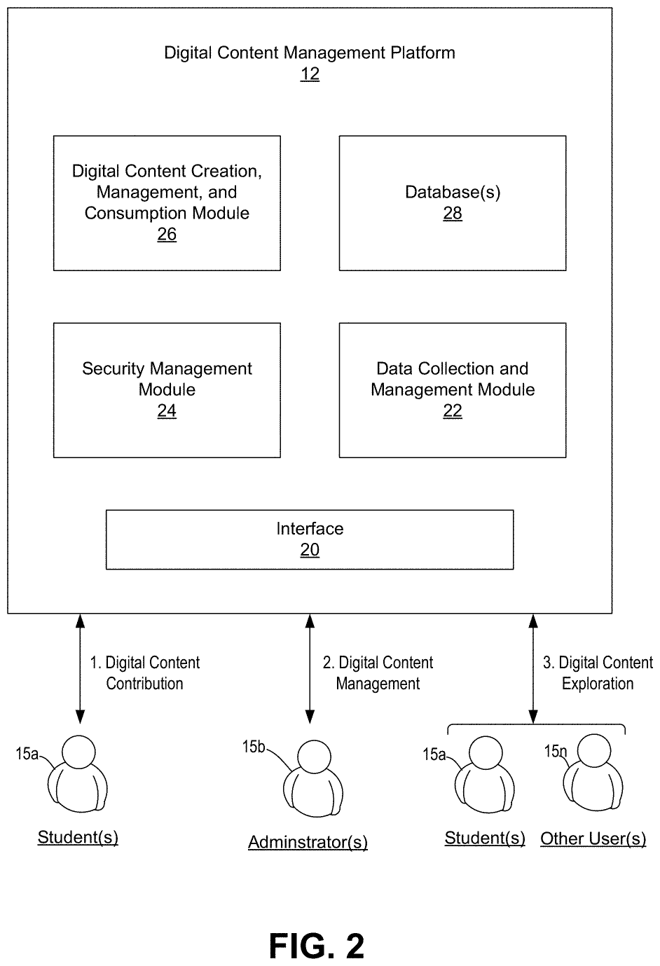

FIG. 2 is a block diagram illustrating the digital content management platform 12 of FIG. 1 in greater detail. As shown, the digital content management platform 12 may include an interface 20, a data collection and management module 22, a security management module 24, a digital content creation, management, and consumption module 26, and various databases 28 for storage of data. As will be described in greater detail herein, the digital content management platform 12 is configured to communicate and share data with one or more users 15(a)-15(n) via computing devices 16(a)-16(n) over a network 18, for example. In the present context, students 15a of the educational institution (also referred to herein as “school”) may communicate with the platform 12 and contribute digital content (i.e., digital images, videos, audio files, text, etc.) associated with specific printed content of the interactive yearbook. Administrators 15b, which may include staff associated with the interactive yearbook (i.e., tasked with the creation and/or management of the interactive yearbook) may communicate with the platform 12 and manage various aspects of the digital content and users. Yet still, students 15a and other users 15n (i.e., individuals associated with a given student, such as a friend or family member, or an individual viewing the interactive yearbook) may communication with the platform 12 and request for access to, and exploration of, user-contributed digital content based on their interaction with the yearbook.

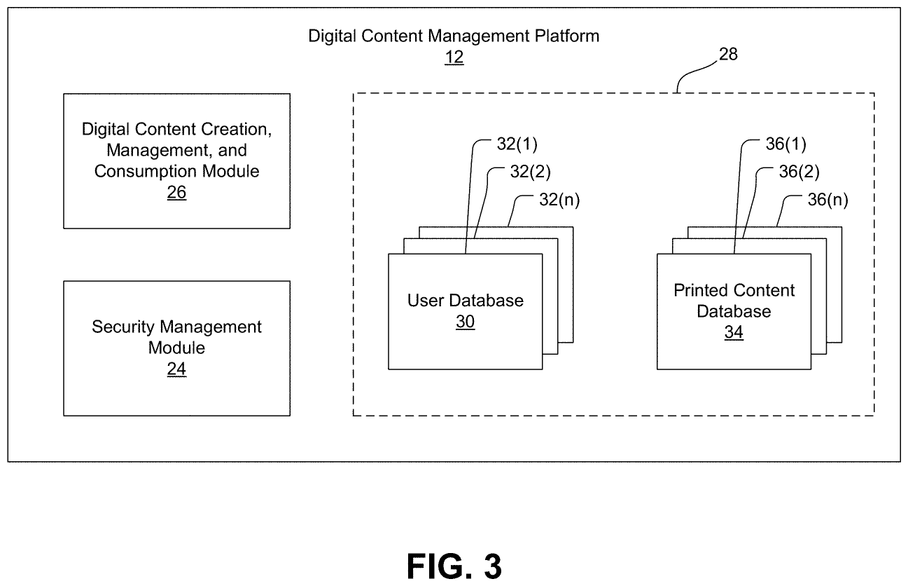

FIG. 3 is a block diagram illustrating the various databases in greater detail. In particular, the various databases for storage of data include, but are not limited to, a user database 30 for storing profiles 32(1)-32(n) (also referred to herein as “user accounts”) associated with at least the students 15a and administrators 15b and a database 34 for storing data associated with the content to be, or already, printed in the associated physical yearbook (also referred to herein as “printed content database 34”), which consists of individual printed content 36(1)-36(n). As will be described in greater detail herein, a given user account 32 may be associated with a student, and thus may include one or more sets of digital content uploaded by the student. The digital content may include, but is not limited to, digital images, videos, audio files, and text, for example. The printed content may include, for example, portrait photographs of each student of the given school. The printed content may also include printed images, graphics, or descriptions related to certain school life topics, such as athletics, organizations, clubs, activities, and school events. The data collection and management module 22 may be configured to communicate and exchange data with each of the databases, as well as the other modules provided.

Each user account 32(1)-32(n) includes basic information about the user, such as their name and other identifying information, contact details (i.e., email address, phone number, mailing address), as well as other school-related details. For example, a student's user account may include their class year, specific activities that the student participated in or are interested in, as well as one or more sets of student-contributed digital content associated with respective printed content in the yearbook. An administrator's user account may include their specific role (i.e., an advisor, yearbook staff, a representative for), wherein each role may have different management features available.

The interface 20 may generally allow a user to gain access to one or more features of the yearbook services, including access to data on the digital content management platform 12, via a software application running on an associated computing device, or via a web-based portal. For example, in a web-based portal, the interface 20 may be presented to the user via their device 16, in which the user may navigate a dashboard or standard platform interface so as to interact with one or more features provided by the yearbook services of the platform 12 and/or view data (stored in one or more of the databases). It should be noted, however, that, depending on the desired customization, certain data may have restricted access in place such that only those users that have been granted rights (e.g., role-based access) can access and view certain data that is considered confidential or sensitive. Accordingly, a user, upon registering or logging in to the yearbook service, via the interface 20, may only have access to certain features. For example, a student 15a may be able to view their own user account, including basic identification details and preferences, as well as the ability to manage their selected digital content that they contributed, including adding, removing, and arranging the display of the digital content). An administrator 15b may have greater access to data and/or more features of the yearbook service than the student 15a, as any given administrator 15b may be able to view multiple student accounts, as well as, in some instances, other administrator accounts. An administrator 15b may further be able to remove any given user-contributed digital content, either as a result of a content moderation process (i.e., the administrator deems certain content uploaded by a student fails to comply with school policies and is thus deemed inappropriate) or as a result of such content being flagged by other users upon such users accessing and exploring the user-contributed digital content during an exploration experience.

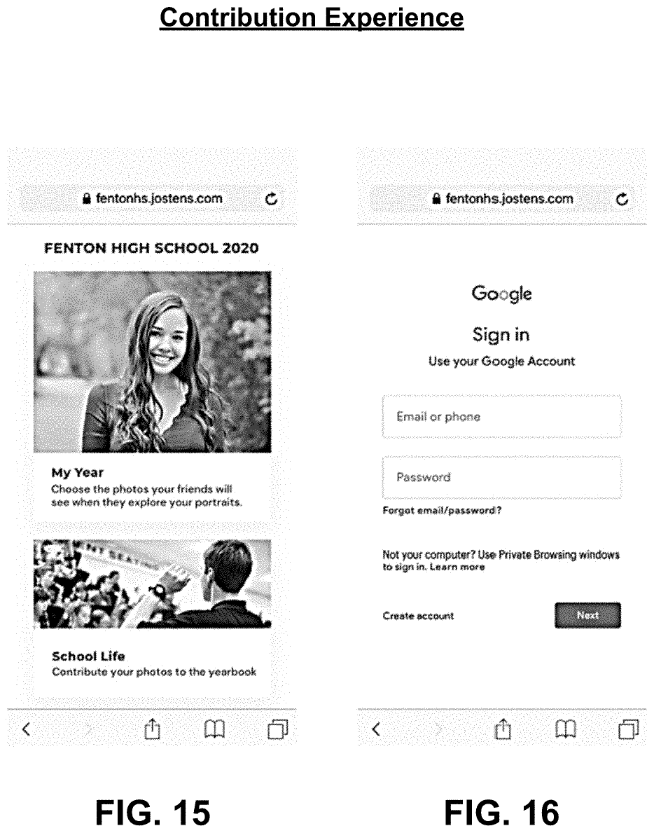

As will be described in greater detail herein, particularly with regard to screenshots of FIGS. 15-25B, the interface 20 generally provides a portal including various interfaces (e.g., digital content contribution interface, digital content management interface, and digital content exploration interface) providing respective users with the ability to interact with the platform 12, specifically the digital content for either contribution, management, or viewing/exploration (depending on the user's role).

As previously described, the platform 12 allows for certain users, specifically students 15a, to contribute digital content (i.e., digital images, videos, audio files, text, etc.) to be associated with specific printed content of the yearbook. The platform 12 may be initially populated with student names and printed content (i.e., either content that has already been printed in the yearbook or content that has not yet been, but will be, printed in the yearbook). In other words, yearbook staff may have already determined the overall layout, design, or theme of the physical yearbook, and have further decided upon the particular content that will be printed in the physical yearbook. Accordingly, the associated databases 28 may initially be populated with student names (i.e., each student will have a user account 32 stored in the user database 30) and the printed content (i.e., student portrait photos will be stored in database 34 and associated with the respective user account 32, as well as images or descriptions associated with certain school life topics, such as athletics, organizations, clubs, activities, and school events).

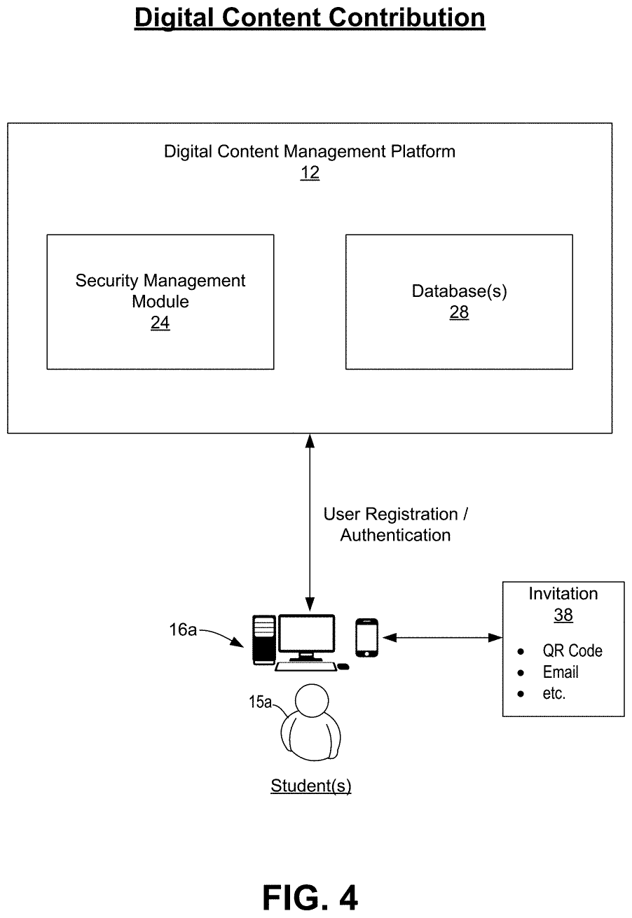

As part of the digital content contribution process, a user may first register with the yearbook services offered by the platform 12 and undergo and authentication process. FIG. 4 is a block diagram illustrating a student 15a communicating with the digital content management platform 12 via their computing device 16a and completing an initial registration process and establishing their identity via an authentication process prior to contributing student-selected digital content. The invitation 38 may be in the form of a printed article, such as a poster or flyer, for example, which includes a machine readable label (i.e., a QR code or the like). Alternatively, the invitation 38 may be an email sent directly to the student. Upon either scanning the machine readable label or clicking a link provided in the email, via their computing device 16, the student is directed to a web-based portal, in which the interface 20 is presented to the user.

At this point, the user must complete an authentication process. The authentication process may include, for example, transmitting a request to the given student to confirm their identity by satisfying at least one of a biometric factor and a challenge-response factor. The biometric factor may include, but is not limited to, a fingerprint scan, a retinal scan, a facial scan, voice recognition, and speech recognition. The challenge-response factor may include, but is not limited to, password authentication, passphrase authentication, and email authentication, for example.

The security management module 24 may generally include authentication and access architecture based on relationship groups that align users 15 with one or multiple groups depending on the users 15 role (e.g., student, administrator, other user, etc.). For example, as part of the authentication and access architecture, the platform 12 is configured to verify certain credentials of a student 15 and determine whether they are registered with the platform 12 (i.e., whether they have a user account 32 stored within the user database 30). If so, the security management module 24 will provide the student 15 with an interface limiting access to only the data to which the authenticated student 15 is permitted. For example, the authentication process may include a typical login scenario in which a student must log in to the platform 12 by providing credentials (e.g., username, password, etc.), wherein the platform 12 will compare the credentials with a user database 30 composed of user accounts 32(1)-32(n) to determine whether the user is allowed access.

As previously described, the security management module 24 may be configured to carry out at least one of facial-recognition analysis and keypoint detection analysis to confirm an identity of a given student during an authentication process. As generally understood, facial recognition is based on a Convolutional Neural Network pretrained with a large dataset of faces that allows for transfer learning. Transfer learning provides the ability to pass single instance of a student's face that trains the network to recognize each student based on vectors derived directly from their face. So, in this instance, each user account 32(1)-32(n) may include identifying data, such as facial recognition data, specific to that given student, wherein such facial recognition data is derived at least from each student's portrait photo. It should be noted that the system can be further trained with additional photos of each student's face. Keypoint detection is a technique based on finding “keypoints” within an image. Keypoints are essentially spatial locations, or points in the image that define what is interesting or what stands out in the image. Keypoints are invariant to image rotation, shrinkage, translation, distortion, and so on. In one instance, a keypoint may generally include a pixel within an image where surrounding pixels may change substantially.

Accordingly, the authentication process may require that the student capture an image of their face, at which point the security management module 24 is configured to process the image data to determine whether the student is in fact authorized to access the platform 12 for purposes of contributing digital content. In particular, processing of the image data may include correlating the image data with stored identifying data in the user database. For example, the security management module 24 may be configured to run an algorithm on the image data received from a given user during the authentication process, wherein the algorithm has been trained on a reference set of data from the user database 30 of constructed profiles or accounts 32 of a plurality of users, the reference set of data including at least one of facial data and keypoint data. For example, the security management module 24 may include custom, proprietary, known and/or after-developed statistical analysis code (or instruction sets), hardware, and/or firmware that are generally well-defined and operable to receive two or more sets of data and identify, at least to a certain extent, a level of correlation and thereby associate the sets of data with one another based on the level of correlation.

Upon a positive correlation, the security management module 24 may deem the student as authentic (i.e., establishing their identity as matching that of a registered user account) and grant the student access to the platform 12 and provide the student with a portal or workspace. Upon a negative correlation, the security management module 24 may deem the student as inauthentic (i.e., unable to identify a matching registered user account) and prevent the student from accessing the platform 12.

As generally understood, the portal or workspace is in the form of an interface (e.g., but not limited to graphical user interface (GUI)) provided on the student's computing device through which the student may interact with the platform 12. The interface 20 provides consistent access to data and information that a specific user is permitted to have access to.

It should be noted that the same authentication process may be implemented for administrators 15b attempting to access the platform 12. In other words, administrators must necessarily successfully undergo an authentication process before gaining access to the platform 12 to carry out management functions.

It should further be noted that a user may further be required to agree to terms and conditions prior to contributing digital content, managing content, and/or viewing/exploring digital content.

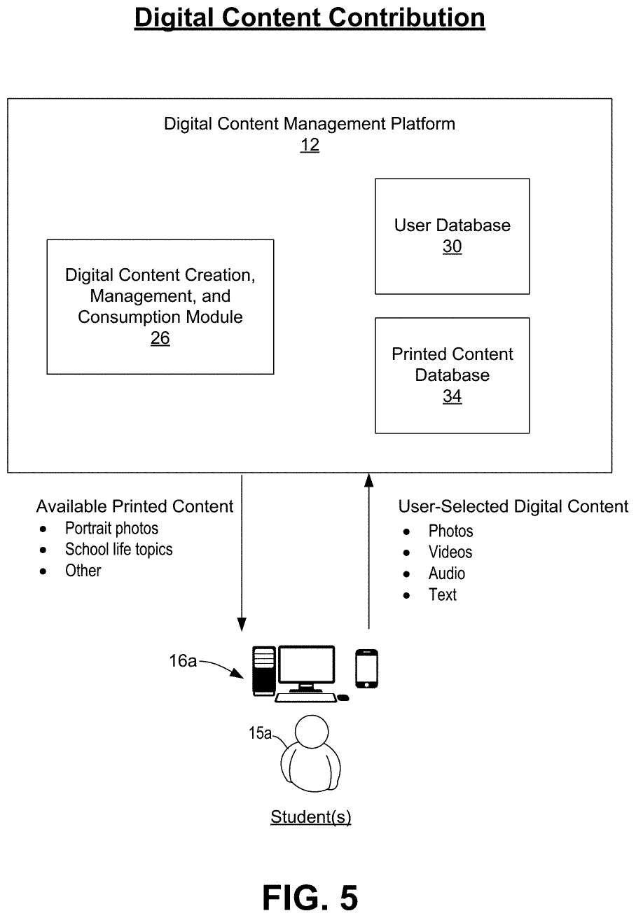

FIG. 5 is a block diagram illustrating communication and exchange of data between the student and the digital content management platform 12, including the contribution of student-selected digital content to be tied to respective printed content of the yearbook. Upon registering with the platform 12 and further passing an authentication process to establish their identity, a student is given the option to supplement certain printed content in the yearbook with digital content of their choosing, which will be available, via the platform 12, for other users to view. The printed content in the yearbook may include, for example, a portrait photograph of the given student that will be printed in the yearbook. The printed content in the yearbook may also be related to certain school life topics, such as athletics, organizations, clubs, activities, and school events. The platform allows for the student to select digital content of their choice to be associated with specific printed content. In one instance, a student may contribute (i.e., upload) a set of digital images to the platform to be associated their portrait photograph, for example.

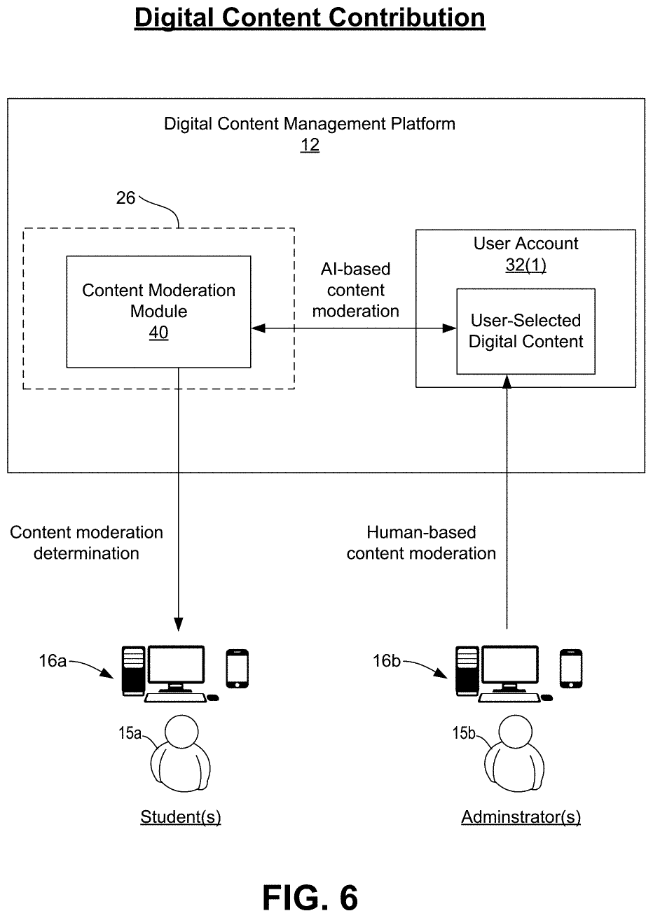

In turn, the contributed digital content undergoes a content moderation process to ensure that the digital content is in compliance with policies instituted by the school (or other governing body). FIG. 6 is a block diagram illustrating the user-contributed digital content undergoing a content moderation process to determine whether the digital content complies with policies governing the appropriateness of digital content to be stored and subsequently accessed for viewing. The policies may generally cover the appropriateness of content to be shared via the platform 12. For example, such policies may include restricting content that shows or otherwise conveys at least one of illegal activities, malicious or deceptive practices, hate speech, harassment, bullying, and threats, personal and confidential information, child safety, sexually explicit material, and violence.

The content moderation process may include, for example, an artificial intelligence (AI)-based content moderation process and/or a human-based content moderation process. Each of the AI-based and human-based content moderation processes comprises review of user-contributed digital content and a determination of whether subject matter of the user-contributed digital content complies with the policies. For example, a content moderation module 40 may be configured to run an AI-based moderation process on the user-contributed digital content. The AI-based moderation process may be based on moderation services, such as WebPurify or AWS Rekognition, for example. The human-based moderation process involves review of the user-contributed digital content by an administrator, for example.

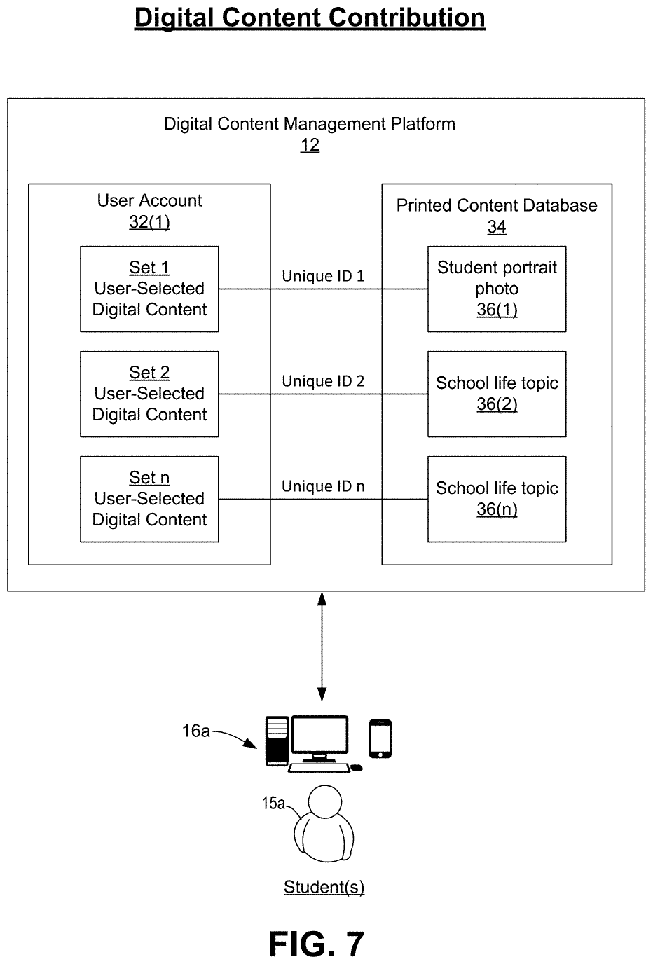

If any of the digital content is not in compliance with the policies, such digital content is flagged and the student is alerted. If, however, the contributed digital content is found to be in compliance with the policies, such digital content is stored within the user account 32 within the user database 30 and further associated with the particular printed content (i.e., the student's portrait photograph or specific school life topic) via a unique identifier, for example. FIG. 7 is a block diagram illustrating the association of one or more sets of user-contributed digital content to separate respective printed content from the yearbook via a unique identifier. Accordingly, a given set of user-contributed digital content is associated with respective content to be printed in the yearbook.

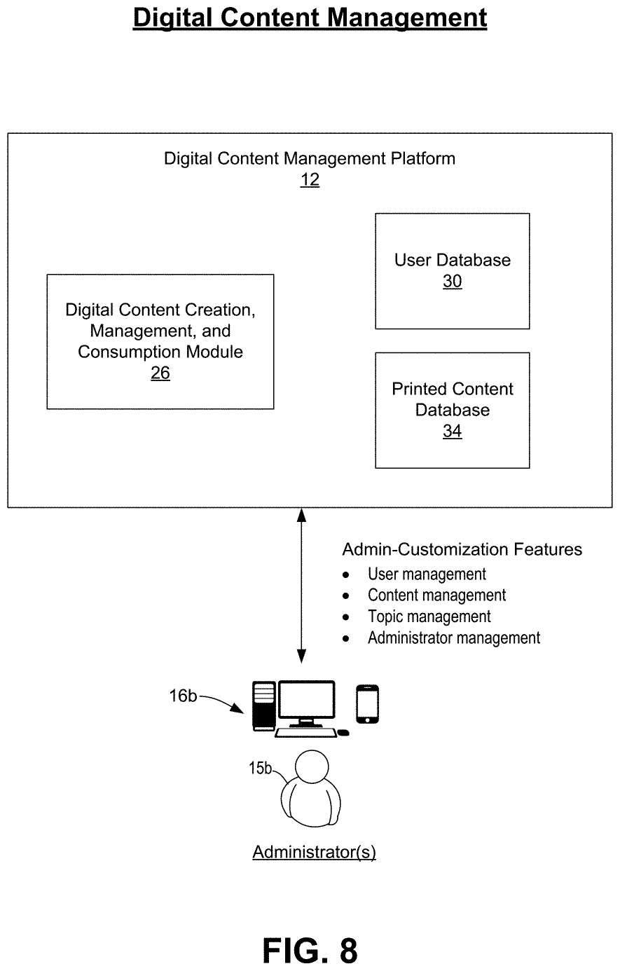

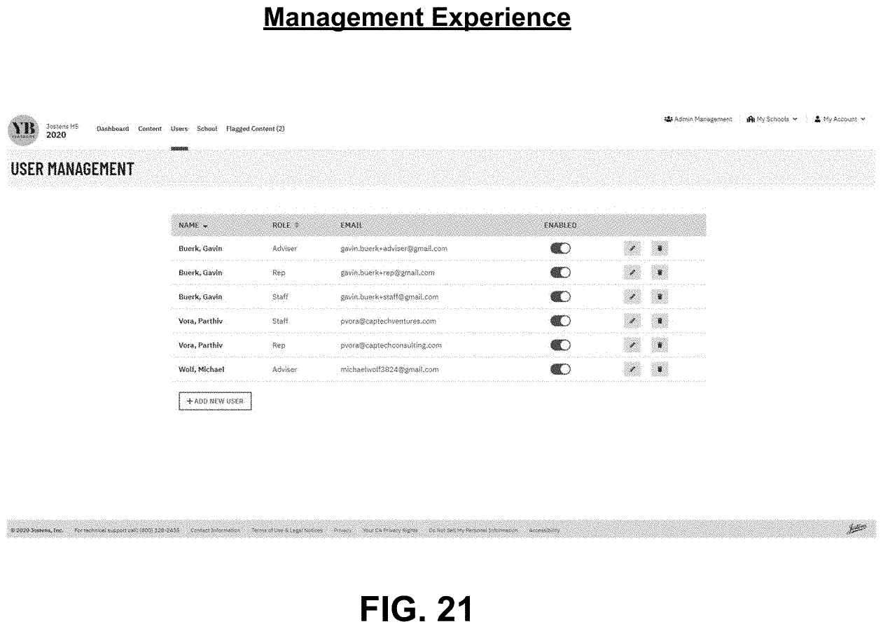

FIG. 8 is a block diagram illustrating an administrator 15b communicating with the digital content management platform 12 and managing digital content, as well as managing users, via a variety of management and customization features. As previously described, certain users may include staff associated with the yearbook and tasked with the creation and/or management of the yearbook. Such staff may include employees of the educational institution and/or representatives of the company providing the yearbook and associated platform. Accordingly, such users may be provided with administrative capabilities, such as managing users and the contribution of digital content therefrom (i.e., providing content moderation, determining which printed content will be available for digital content to be tied thereto, determining the amount of allowed digital content for any given printed content, etc.), managing the design and layout of both the printed content in the yearbook and the digital content to be presented via the platform, managing access to such digital content, as well as managing the administrative capabilities of other users. The various management features available to administrators are described in greater detail herein with respect to FIGS. 21, 22A, 22B, 23A, 23B, 23C, 24A, 24B, 25A, and 25B, which include screenshots of interfaces specific to administrators.

As previously described, the platform 12 allows for users to access and explore user-contributed digital content. In order to gain access to the platform 12 for subsequent exploration of such digital content, a user must first complete an onboarding process.

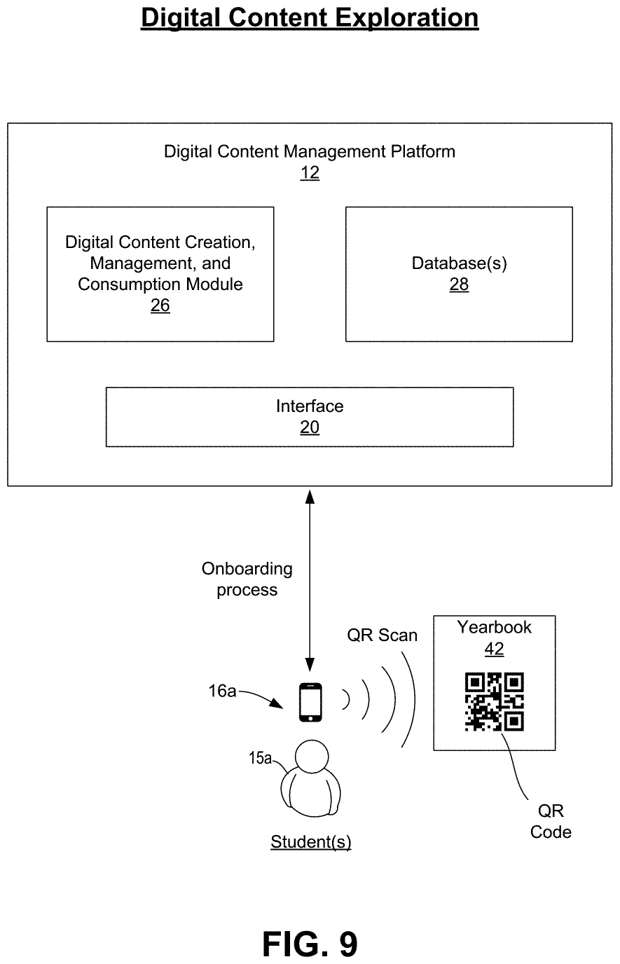

FIG. 9 is a block diagram illustrating a user communicating with the digital content management platform 12 via a personal computing device, such as a smartphone or tablet and completing an initial onboarding process in order to access the platform 12 and subsequently gain access to and explore user-contributed digital content. As shown, a printed yearbook 42 is provided and includes a machine readable label, such as a QR code. The user need only scan the QR code with their computing device, such as a tablet or smartphone, having image scanning and/or capturing capabilities (i.e., a camera) in order to capture data associated with a machine readable label printed in the physical yearbook. Once captured via a camera of the user's smartphone or tablet, the QR code redirects the user to a URL, prompting the user to complete an initial onboarding process (i.e., an initial greeting and brief tutorial as to how the digital content exploration process works).

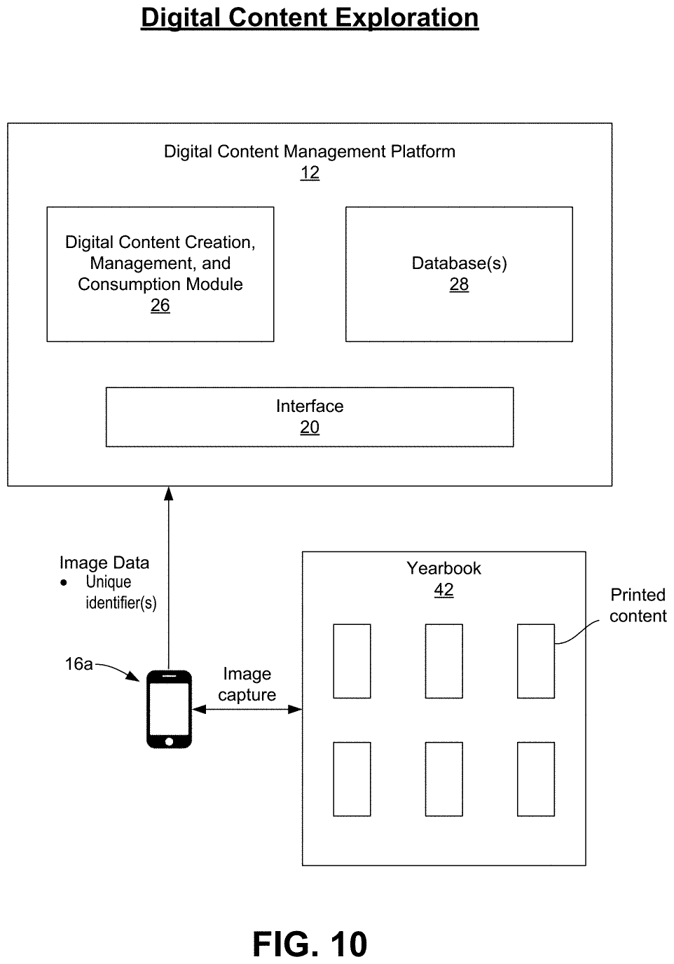

Upon completing the onboarding process, the user is then prompted to use their camera to scan over printed content in the yearbook 42, which may include student portrait photographs or printed content associated with school life topics, for example. FIG. 10 is a block diagram illustrating a user requesting access to user-contributed digital content by transmitting, to the digital content management platform, image data associated with printed content in a yearbook, the image data captured via a camera of the user's computing device. Upon capturing image data associated with the printed content, such as a specific student's portrait photograph, the image data is transmitted to the platform 12 for subsequent determination as to whether such printed content includes associated user-contributed digital content for viewing.

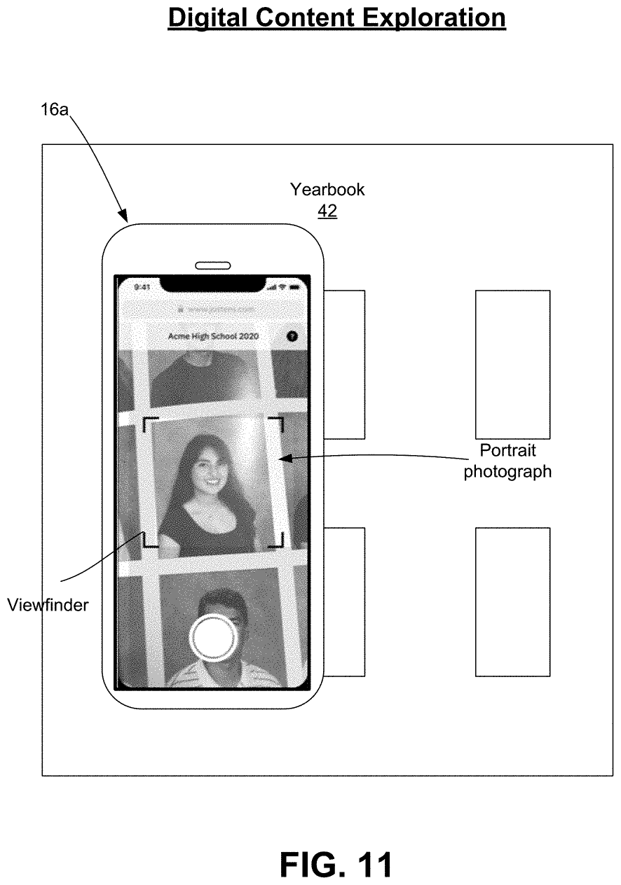

FIG. 11 shows and exemplary smartphone 16a utilizing an integrated camera to scan over printed content in the yearbook and subsequently capture image data associated with the printed content, such as a specific student's portrait photograph.

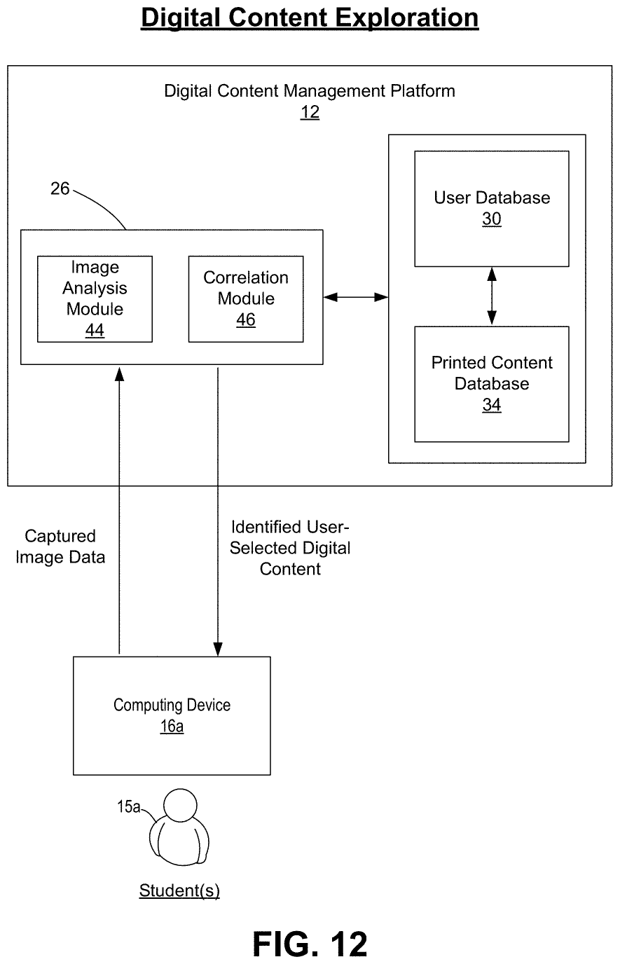

FIG. 12 is a block diagram illustrating processing of the request (i.e., processing of the image data) to identify user-contributed digital content associated with the printed content and subsequent granting of access to and exploration of the identified user-contributed digital content. In particular, upon capturing an image of the printed content (i.e., student portrait), image data associated with the captured image is transmitted to the platform 12, essentially requesting access to user-contributed digital content associated with the printed content. An image analysis module 44 is configured to process the request, notably process the image data to thereby identify one or more unique identifiers associated with the image data. The image analysis may include, for example, facial recognition analysis and/or keypoint detection analysis. Subsequently, a correlation module 46 is configured to correlate the image data (specifically the one or more unique identifiers) with data stored in the databases 28. For example, the correlation module 24 may include custom, proprietary, known and/or after-developed statistical analysis code (or instruction sets), hardware, and/or firmware that are generally well-defined and operable to receive two or more sets of data and identify, at least to a certain extent, a level of correlation and thereby associate the sets of data with one another based on the level of correlation.

The correlation module 46 may correlate the one or more unique identifiers of the image data with identifying data associated with one or more sets of student-contributed digital content and associated printed content. The identifying data may include, for example, unique identifiers of associated printed content. In other words, printed content 36 stored within the printed content database 34 may initially go through an image analysis process to thereby establish one or more unique identifiers associated with each unit of printed content 36. For example, each student portrait photograph may initially undergo facial recognition analysis and/or keypoint detection analysis to thereby establish one or more unique identifiers associated therewith (i.e., vector data and/or keypoint data, respectively). Accordingly, the unique identifiers of the image data (included in the request) are correlated with unique identifiers of each unit of printed content stored in the printed content database 34.

Upon a positive correlation, the requesting user is granted access to a corresponding set of user-contributed digital content. However, upon a negative correlation, it is determined that there is no digital content available (i.e., the student of that particular portrait has not yet contributed and digital content for their portrait photograph) and the platform 12 provides the requesting user with a message indicating so. In some instances, the correlation results may indicate a close match, such that the platform 12 may further prompt the requesting user to enter additional information, such as a student name that they are searching for. In turn, the additional information will help refine the search and narrow down the number of potential matches.

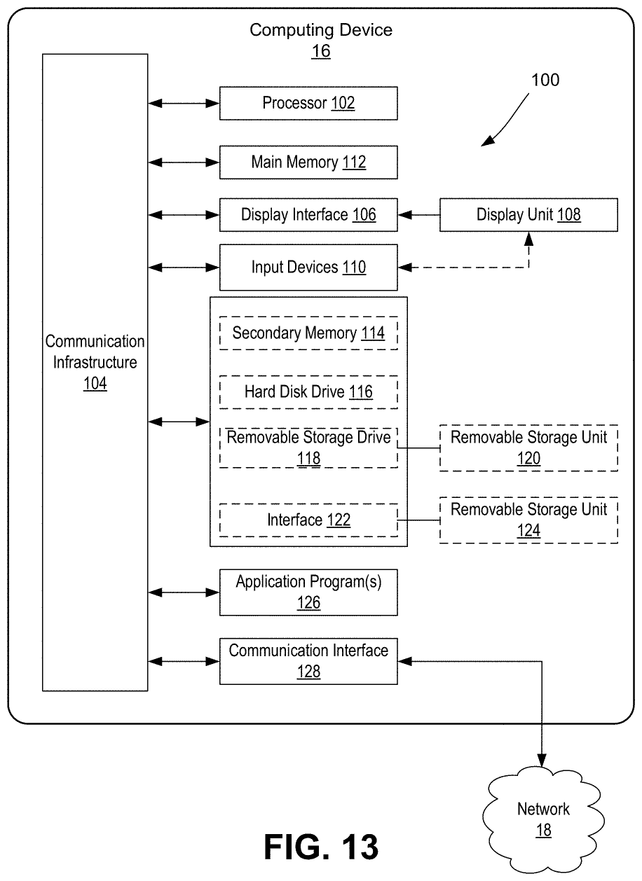

FIG. 13 is a block diagram illustrating at least one embodiment of a computing device (i.e., smartphone or tablet) 16 for communicating with the digital content management platform 12 and allowing an associated user to interact with the platform to at least contribute selected digital content and/or access and explore user-contributed digital content.

The mobile device 16 generally includes a computing system 100. As shown, the computing system 100 includes one or more processors, such as processor 102. Processor 102 is operably connected to communication infrastructure 304 (e.g., a communications bus, cross-over bar, or network). The processor 102 may be embodied as any type of processor capable of performing the functions described herein. For example, the processor may be embodied as a single or multi-core processor(s), digital signal processor, microcontroller, or other processor or processing/controlling circuit.

The computing system 100 further includes a display interface 106 that forwards graphics, text, sounds, and other data from communication infrastructure 104 (or from a frame buffer not shown) for display on display unit 108. The computing system further includes input devices 110. The input devices 110 may include one or more devices for interacting with the mobile device 16, such as a keypad, microphone, camera, as well as other input components, including motion sensors, and the like. In one embodiment, the display unit 108 may include a touch-sensitive display (also known as “touch screens” or “touchscreens”), in addition to, or as an alternative to, physical push-button keyboard or the like. The touch screen may generally display graphics and text, as well as provides a user interface (e.g., but not limited to graphical user interface (GUI)) through which a user may interact with the mobile device 16, such as accessing and interacting with applications executed on the device 16, including an app for providing direct user input with the yearbook service offered by the digital content management platform.

The computing system 100 further includes main memory 112, such as random access memory (RAM), and may also include secondary memory 114. The main memory 112 and secondary memory 114 may be embodied as any type of device or devices configured for short-term or long-term storage of data such as, for example, memory devices and circuits, memory cards, hard disk drives, solid-state drives, or other data storage devices. Similarly, the memory 112, 114 may be embodied as any type of volatile or non-volatile memory or data storage capable of performing the functions described herein.

In the illustrative embodiment, the mobile device 16 may maintain one or more application programs, databases, media and/or other information in the main and/or secondary memory 112, 114. The secondary memory 114 may include, for example, a hard disk drive 116 and/or removable storage drive 118, representing a floppy disk drive, a magnetic tape drive, an optical disk drive, etc. Removable storage drive 318 reads from and/or writes to removable storage unit 120 in any known manner. The removable storage unit 120 may represents a floppy disk, magnetic tape, optical disk, etc. which is read by and written to by removable storage drive 118. As will be appreciated, removable storage unit 120 includes a computer usable storage medium having stored therein computer software and/or data.

In alternative embodiments, the secondary memory 114 may include other similar devices for allowing computer programs or other instructions to be loaded into the computing system 100. Such devices may include, for example, a removable storage unit 124 and interface 122. Examples of such may include a program cartridge and cartridge interface (such as that found in video game devices), a removable memory chip (such as an erasable programmable read only memory (EPROM), or programmable read only memory (PROM)) and associated socket, and other removable storage units 124 and interfaces 122, which allow software and data to be transferred from removable storage unit 124 to the computing system 100.

The computing system 100 further includes one or more application programs 126 directly stored thereon. The application program(s) 126 may include any number of different software application programs, each configured to execute a specific task.

The computing system 100 further includes a communications interface 128. The communications interface 128 may be embodied as any communication circuit, device, or collection thereof, capable of enabling communications between the mobile device 16 external devices (other mobile devices 16, the cloud-based service 14, including the digital content management platform 12). The communications interface 128 may be configured to use any one or more communication technology and associated protocols, as described above, to effect such communication. For example, the communications interface 128 may be configured to communicate and exchange data with the digital content management platform 12, and/or one other mobile device 16, via a wireless transmission protocol including, but not limited to, Bluetooth communication, infrared communication, near field communication (NFC), radio-frequency identification (RFID) communication, cellular network communication, the most recently published versions of IEEE 802.11 transmission protocol standards, and a combination thereof. Examples of communications interface 128 may include a modem, a network interface (such as an Ethernet card), a communications port, a Personal Computer Memory Card International Association (PCMCIA) slot and card, wireless communication circuitry, etc.

Computer programs (also referred to as computer control logic) may be stored in main memory 112 and/or secondary memory 114 or a local database on the mobile device 16. Computer programs may also be received via communications interface 128. Such computer programs, when executed, enable the computing system 100 to perform the features of the present invention, as discussed herein. In particular, the computer programs, including application programs 126, when executed, enable processor 102 to perform the features of the present invention. Accordingly, such computer programs represent controllers of computer system 100.

In one embodiment where the invention is implemented using software, the software may be stored in a computer program product and loaded into the computing system 100 using removable storage drive 118, hard drive 116 or communications interface 128. The control logic (software), when executed by processor 102, causes processor 102 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

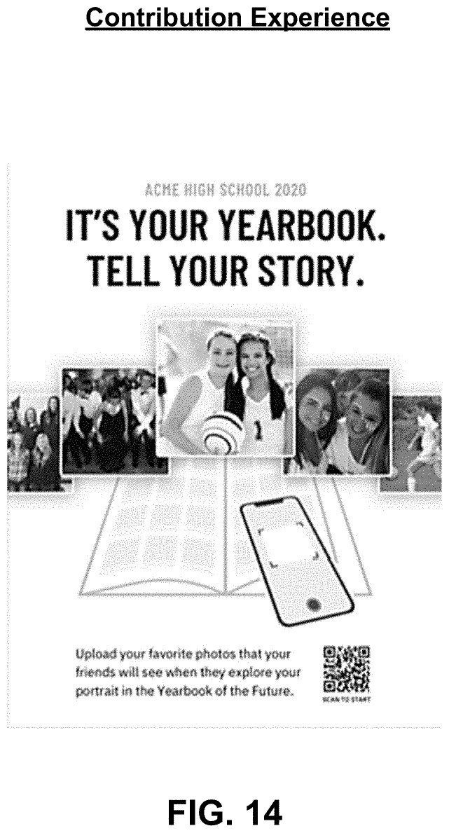

FIGS. 14, 15, 16, 17A-17D, and 18A-18F illustrate various aspects of a contribution experience consistent with the present disclosure. As previously described, the platform 12 allows for certain users, such as the students, to contribute digital content (i.e., digital images, videos, audio files, text, etc.) associated with specific printed content.

It should be noted that, in some instances, family members or friends of students may also contribute digital content, such as uploading of an advertisement purchased by a parent, for example, for their student. The parent advertisement may include printed content (in the form of a parent advertisement) celebrating their child's achievements, wherein the printed parent advertisement includes a machine readable label, such as a QR code that, once scanned by the student, provides the student with parent-contributed digital content, which may include a video message, for example. The video message may be password protected, for example.

The student contribution experience generally begins with completing an initial registration process and establishing their identity via an authentication process prior to contributing student-selected digital content. FIG. 14 is an exemplary invitation provided to a user (i.e., student) to join (i.e., register with the digital content management platform) and subsequently contribute selected digital content to correspond with specific printed content the student's yearbook.

Upon completing the initial registration process, a student is presented with a landing page. FIG. 15 is a screenshot of an interface displayed on a mobile device of a student, illustrating a landing page in which the student is invited to contribute their own photos for specific printed content (i.e., that student's portrait photograph or school life topics). In some instances, depending on the security practices and policies implemented by a given school, the student may further be required to verify their identity by provided a username and passcode. FIG. 16 is a screenshot of an interface displayed on the user's mobile device illustrating an authentication request.

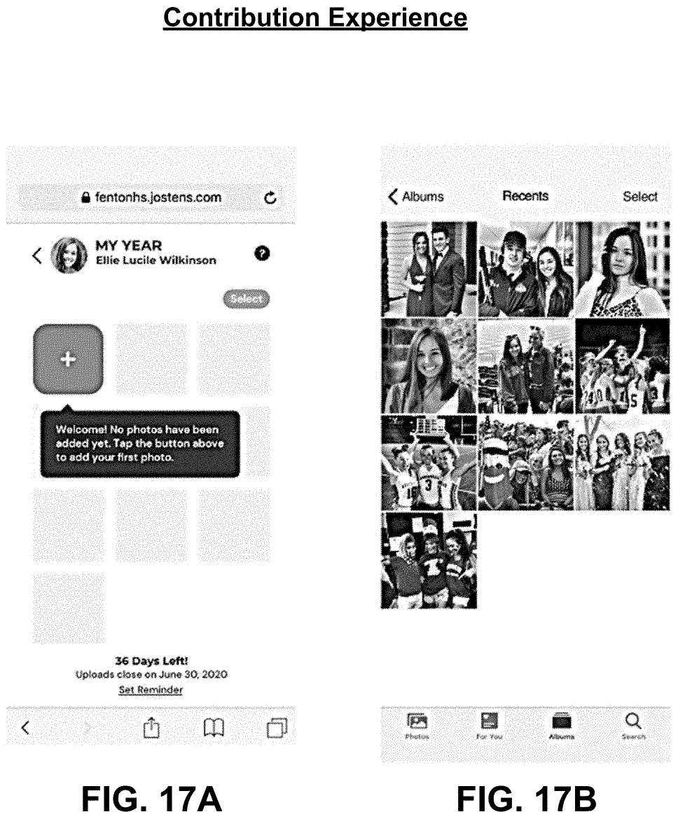

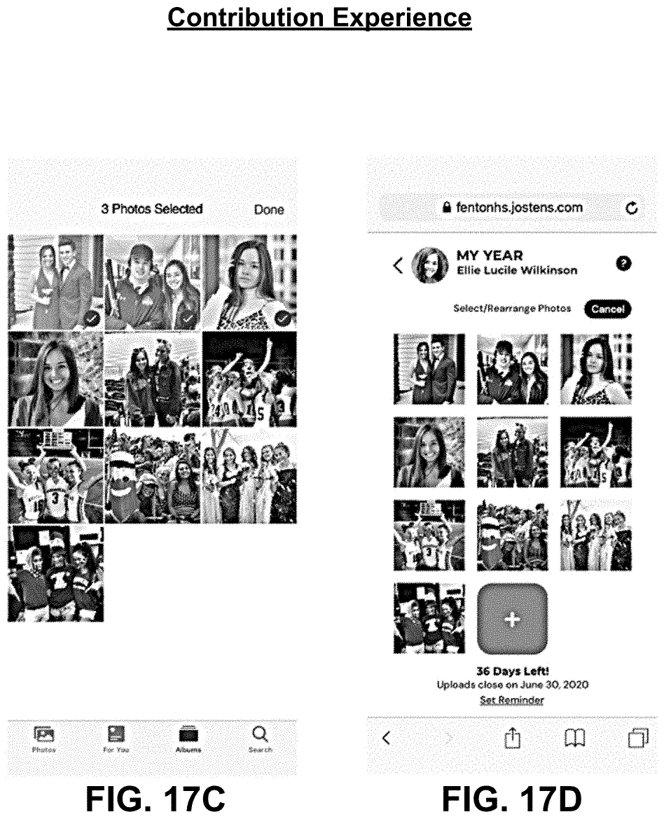

Upon successful authentication, the student is provided with an interface allowing for the uploading student-selected content, such as photos from their own personal library (stored on their smartphone, for example). FIGS. 17A, 17B, 17C, and 17D are screenshots of an interface displayed on the user's mobile device illustrating a user's ability to contribute (i.e., select and arrange) a set of their own digital photos to be associated with their student portrait photograph to be printed in the yearbook. Upon selecting the photos to contribute, the student is further presented with a notice of when the selected photo will be automatically submitted for content moderation (see FIG. 17D). Students can further select for a calendar reminder of the number of days left until automatic submission. Accordingly, students are able to access their account any time prior to submission and update (i.e., add, remove, or rearrange) photos for submission.

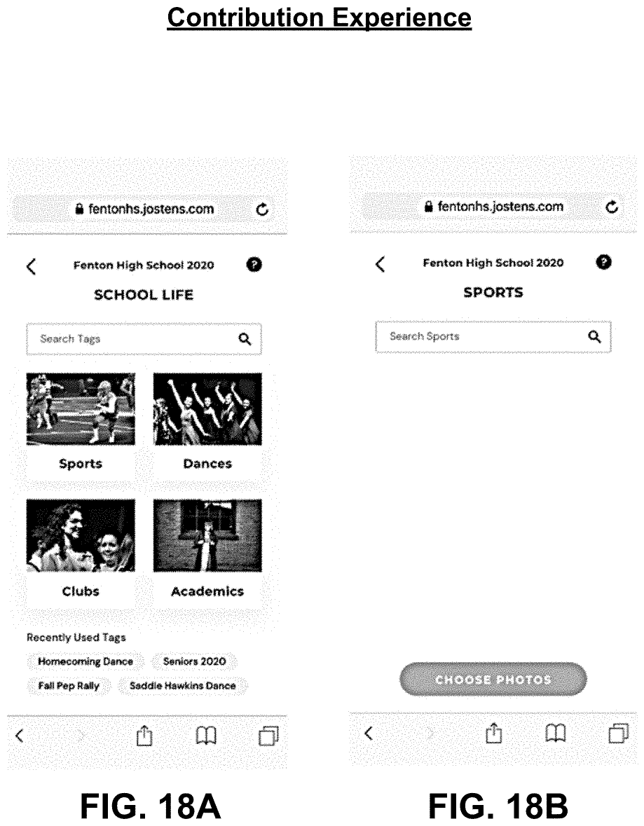

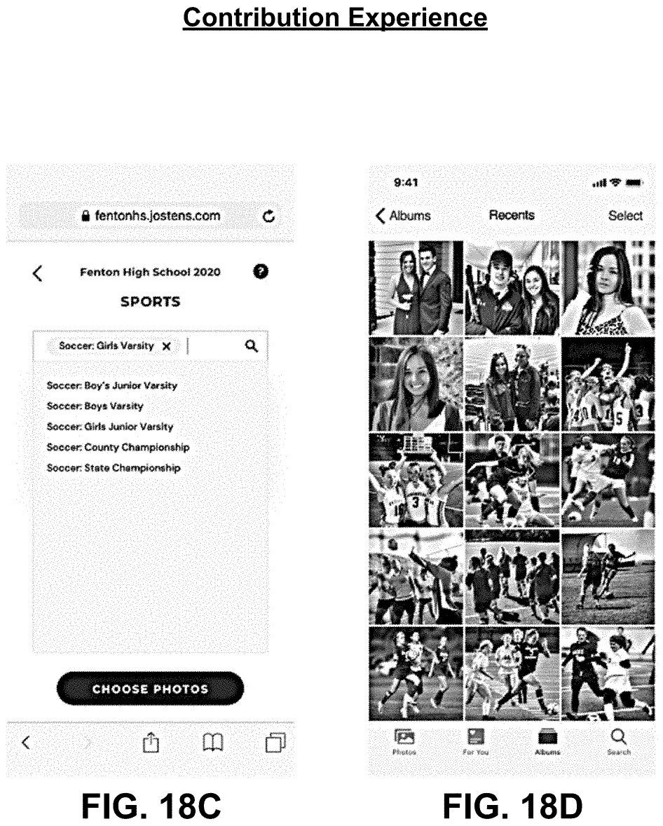

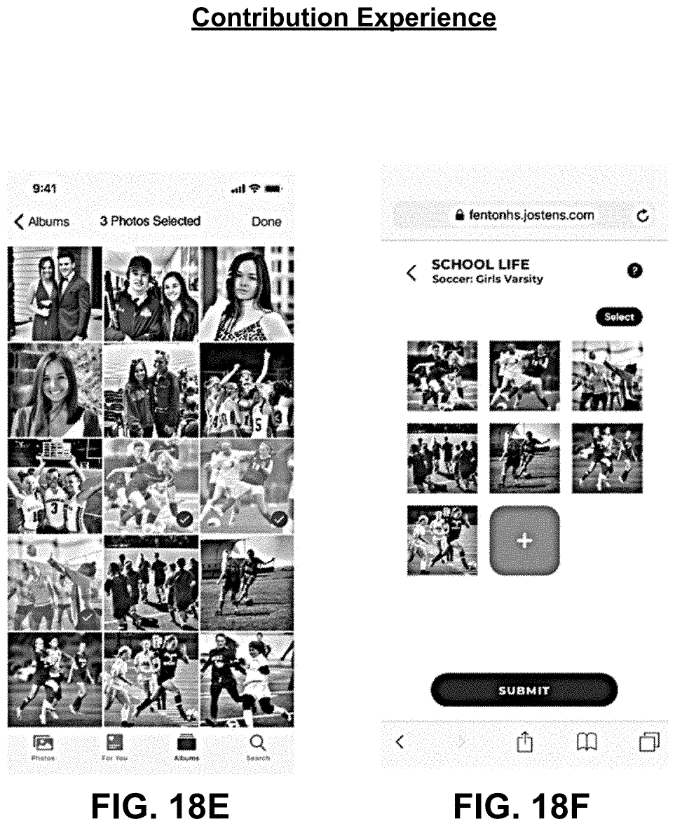

FIGS. 18A, 18B, 18C, 18D, 18E, and 18F are screenshots of an interface displayed on the user's mobile device illustrating a user's ability to contribute (i.e., select and arrange) a set of their own digital photos to be associated with a specific selected school life topic to be printed in the yearbook. As previously described, the printed content in the yearbook may be related to certain school life topics, such as athletics, organizations, clubs, activities, and school events. For example, a student may be presented with various topics to choose from via a school life landing page (see FIG. 18A). The student can search for a specific tag, select a primary category, or pick a personalized recently used tag. As shown in FIG. 18B, if the student chooses “Sports”, they will be redirected to a page in which they can use a search field to manually enter their sports event of interest. For example, as shown in FIG. 18C, a student can enter “soccer: girls varsity” and this will reference a database of sports events and pull the appropriate tagged events. Again, once a specific school life topic and related event is selected, the student is provided with an interface allowing for the uploading student-selected content, such as photos from their own personal library (stored on their smartphone, for example) (see FIGS. 18D, 18E, and 18F).

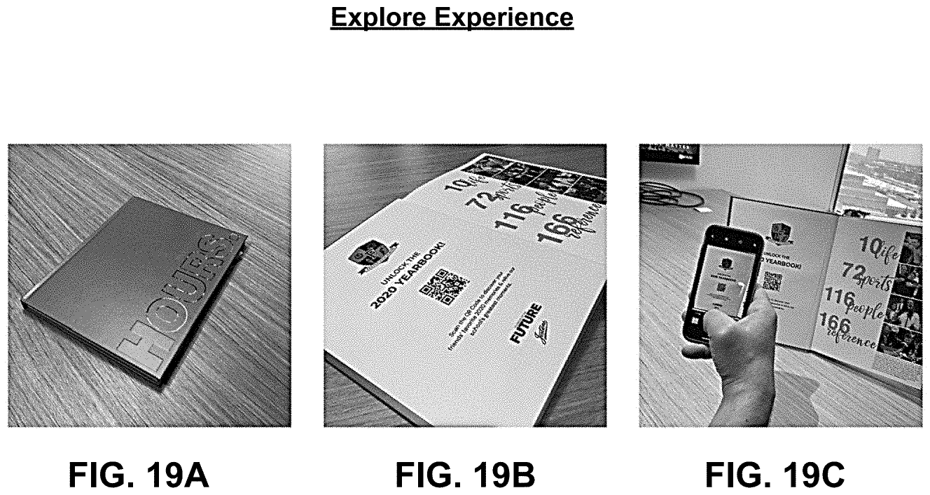

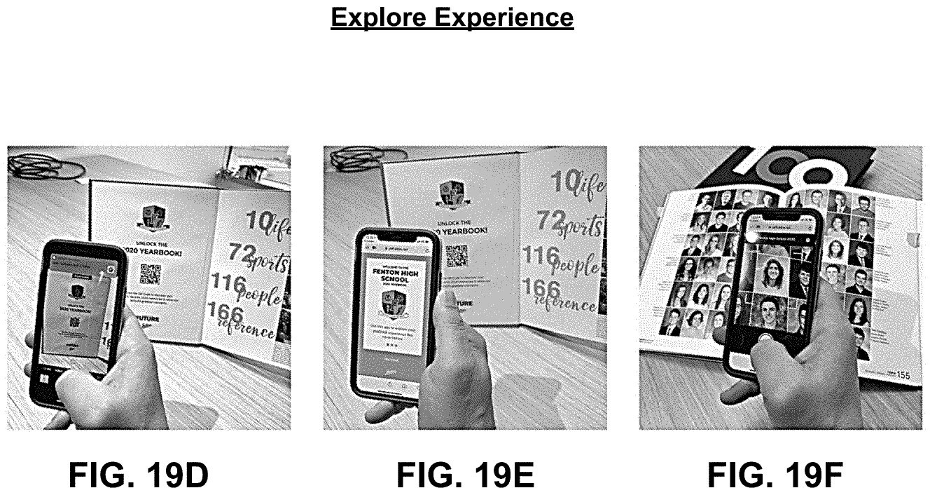

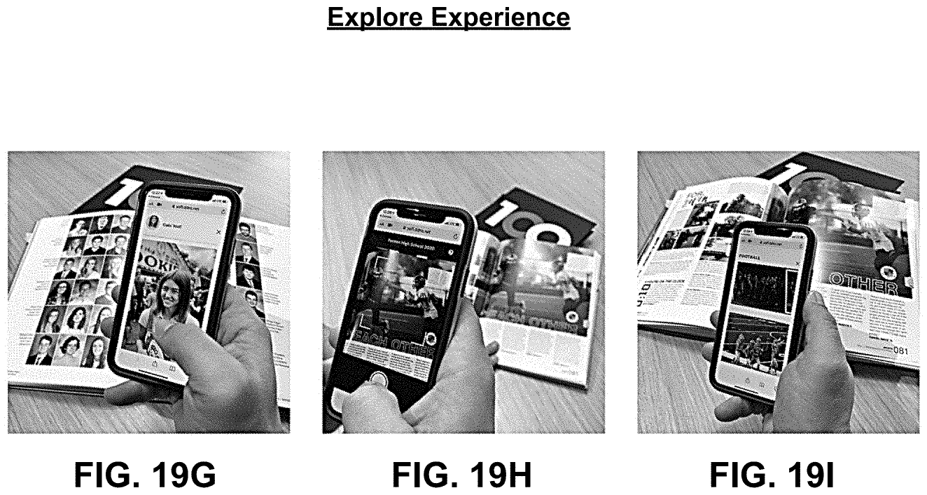

FIGS. 19A, 19B, 19C, 19D, 19E, 19F, 19G, 19H, and 19I are images illustrating the specific steps taken by a user in order to interact with the digital content management platform and request access to user-contributed digital content associated with printed content in the yearbook. As shown, a physical yearbook is provided (FIG. 19A). In order to gain access to and explore student-contributed digital content associated with printed content in the yearbook, a user must first complete an onboarding process. Such a process involves the user utilizing a personal computing device, such as a tablet or smartphone, having image scanning and/or capturing capabilities (i.e., a camera) in order to capture data associated with a machine readable label printed in the physical yearbook.

For example, as shown in FIG. 19B, the yearbook may include a QR code or other machine readable label that, once captured via a camera of the user's smartphone or tablet (see FIG. 19C), results in the user gaining access to the platform. In particular, as shown in FIG. 19D, the operating system of the user's computing device will detect a QR code scan and show a banner to the user including a prompt for launching the internet browser (to thereby redirect the user to a web-based portal for accessing the platform.

The user is then presented with a brief tutorial to educate the user on how to use the explore experience (see FIG. 19E). The web-based app then enables the camera of the user's computing device, thereby allowing the user to scan over printed content in the yearbook, which may include student portrait photographs or printed content associated with school life topics (see FIG. 19F). Upon capturing image data associated with the printed content, such as a specific student's portrait photograph (see FIG. 19G), the platform is able to determine whether such printed content includes associated user-contributed digital content for viewing. If user-contributed digital content is available, the user is then provided with access to viewing such content (see FIG. 19G). FIGS. 19H and 19I illustrate scanning of printed photographs associated with school life topics, such as sports, which results in providing the user with user-contributed digital content associated with the printed content of the sports topics in the yearbook.

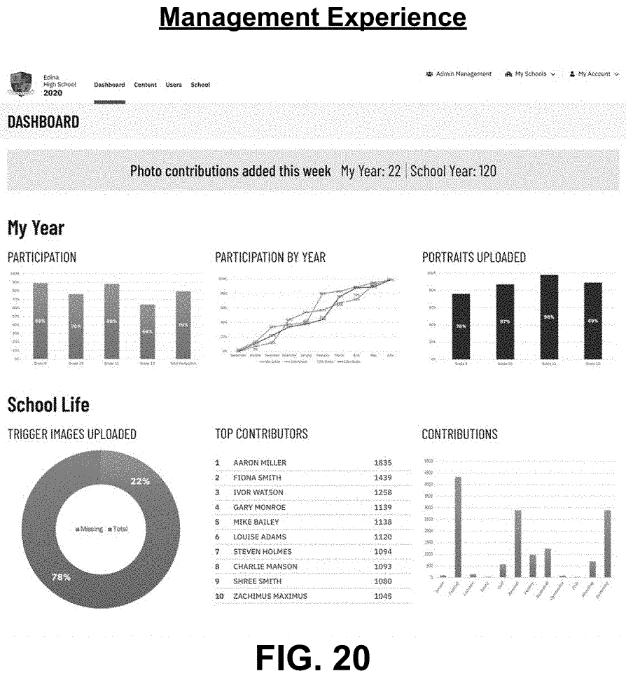

FIGS. 20, 21, 22A, 22B, 23A, 23B, 23C, 24A, 24B, 25A, and 25B are screenshots of an interface displayed on a user's computing device providing the user with various management features, including managing users and the contribution of digital content therefrom (i.e., providing content moderation, determining which printed content will be available for digital content to be tied thereto, determining the amount of allowed digital content for any given printed content, etc.), managing the design and layout of both the printed content in the yearbook and the digital content to be presented via the platform, managing access to such digital content, as well as managing the administrative capabilities of other users.

FIG. 20, for example, is a screenshot of an exemplary dashboard or landing page, which a given administrator may be presented with various visuals and statistics about student participation and contributions and the like. FIG. 21 is a screenshot of a user management interface, in which various administrators are listed, including relevant details of each, such as their role, their email, as well as whether their access to a given schools platform and digital yearbook experience is enabled. Furthermore, the user management interface allows for an administrator of a certain level to add or remove other administrators (whom are at lower levels of authority).

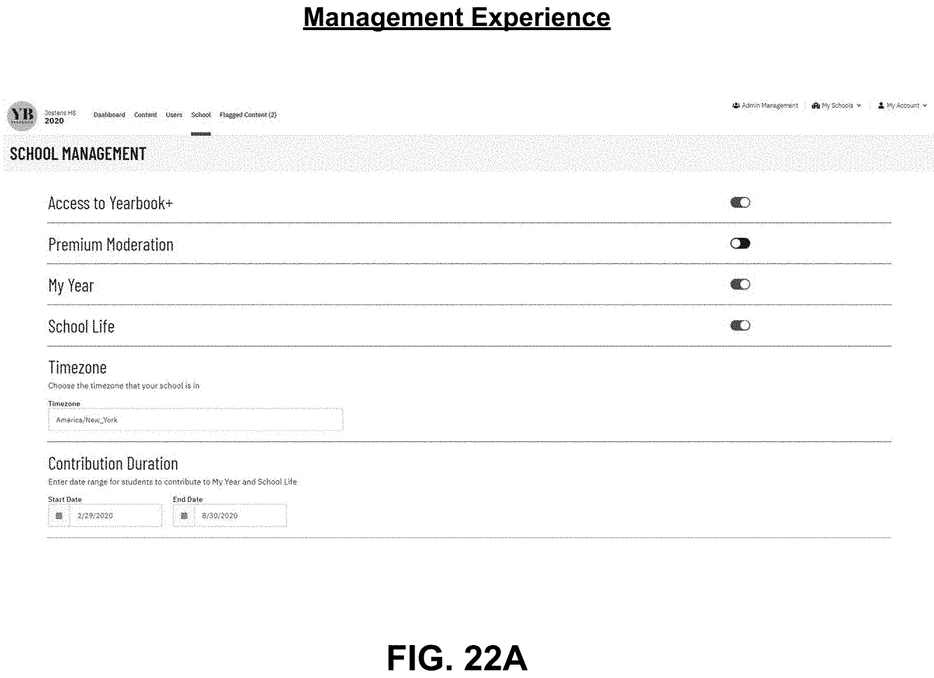

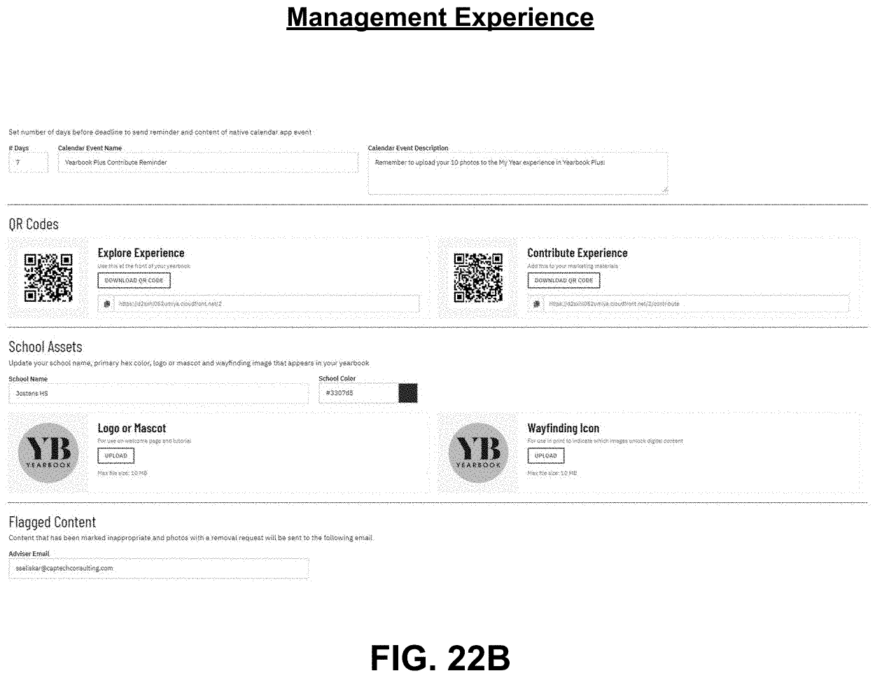

FIGS. 22A and 22B are screenshots of a school management interface, wherein administrators are able to adjust certain settings regarding student access to the yearbook services (for purposes of contributing digital content), as well as set specific contribution dates, uploading of wayfinding icon (an icon for use in printed content to indicate which images unlock digital content), setting of school colors, etc.

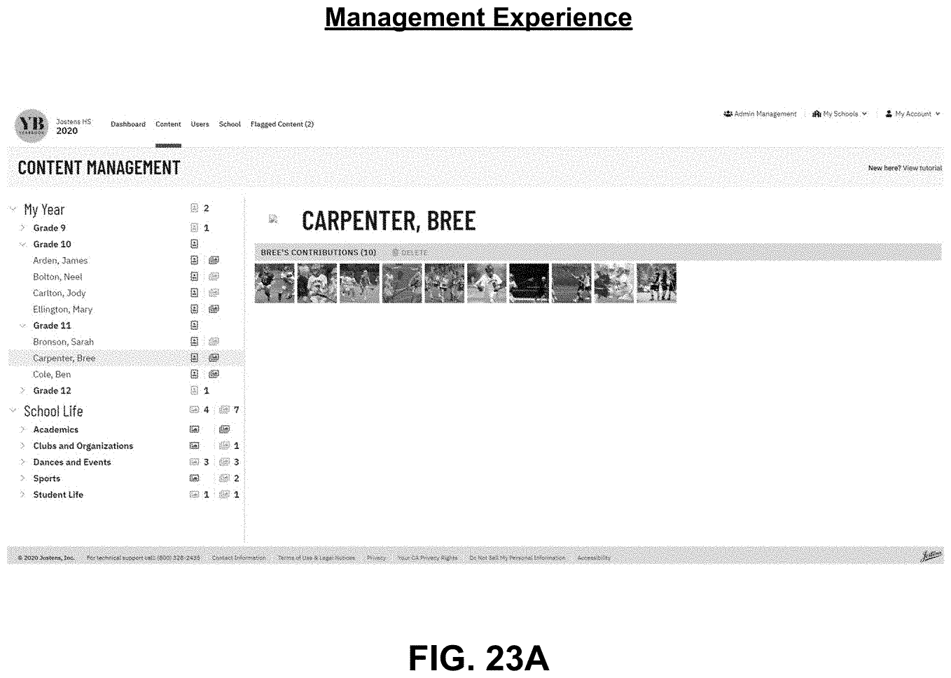

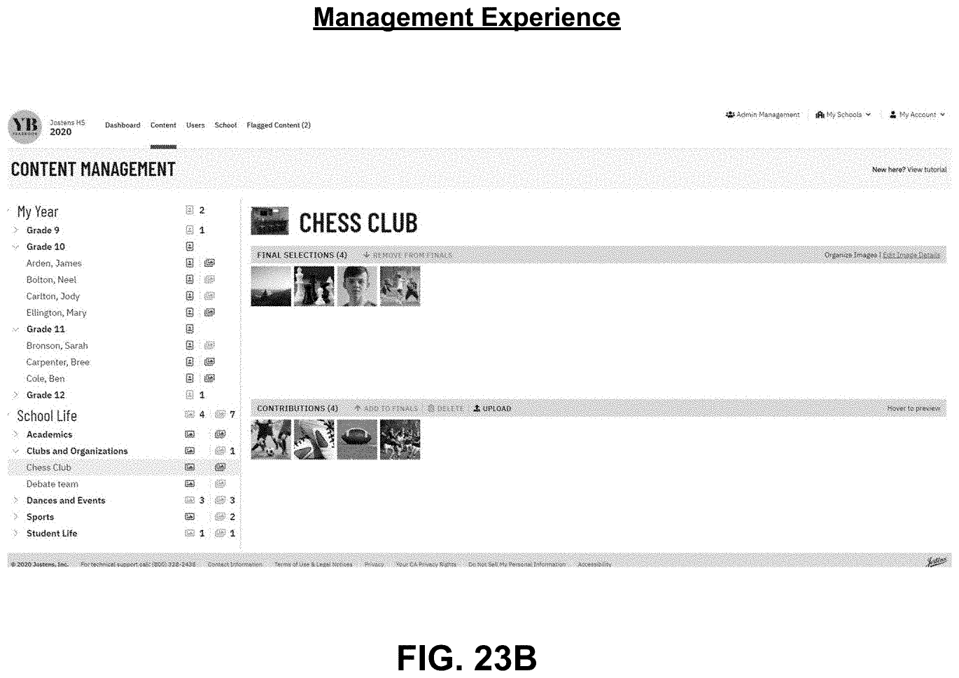

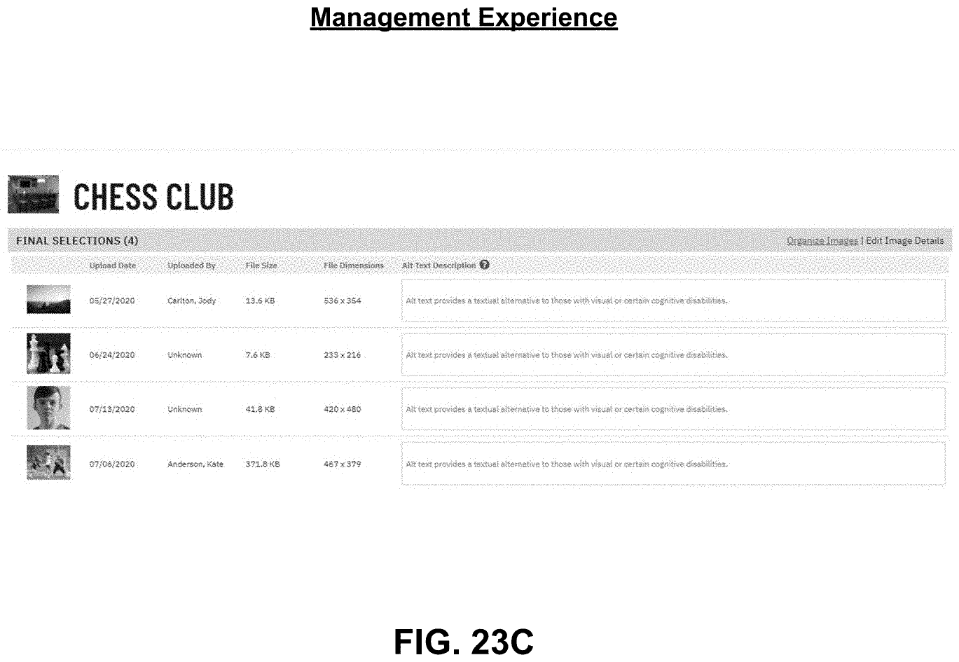

FIGS. 23A, 23B, and 23C are screenshots of a content management interface, in which administrators are able to view student-contributed digital content for specific printed content (i.e., student portrait photos or school life topics). The content management interface provides administrators with various tools for managing not only the student-contributed digital content, but to further manage the printed content. For example, administrators are able to: add, rename, delete categories and topics; add photos to topics by manually uploading; view all photos that have been contributed to topics; move photos from contributions to final selections, rearrange the order of photos within a section; add trigger images (the picture in the physical yearbook that will unlock a topic in the Explore experience); create and update alt-tags, to better meet ADA standards; and delete inappropriate content that made it through initial automated AI-based content moderation process.

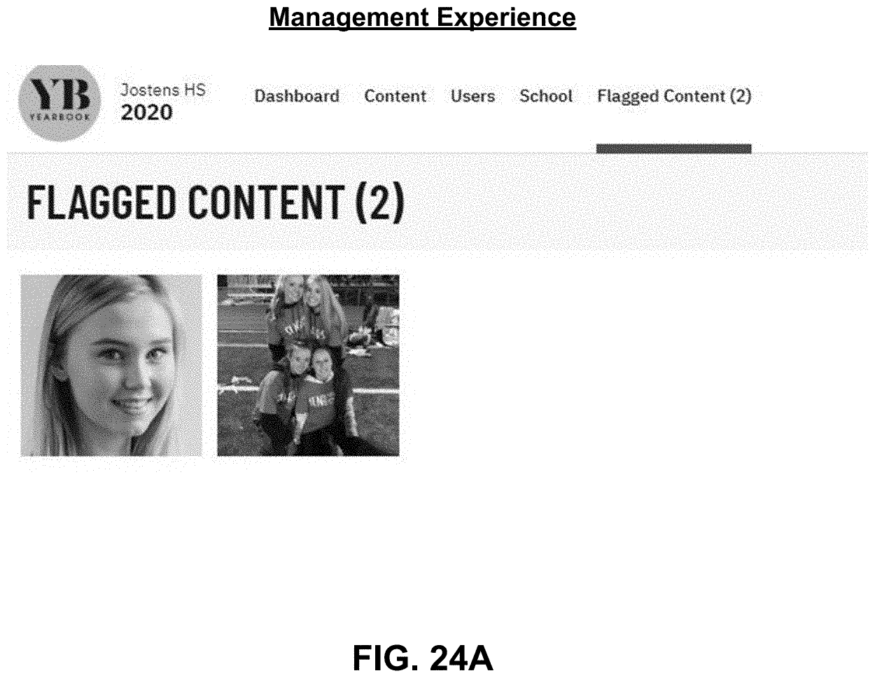

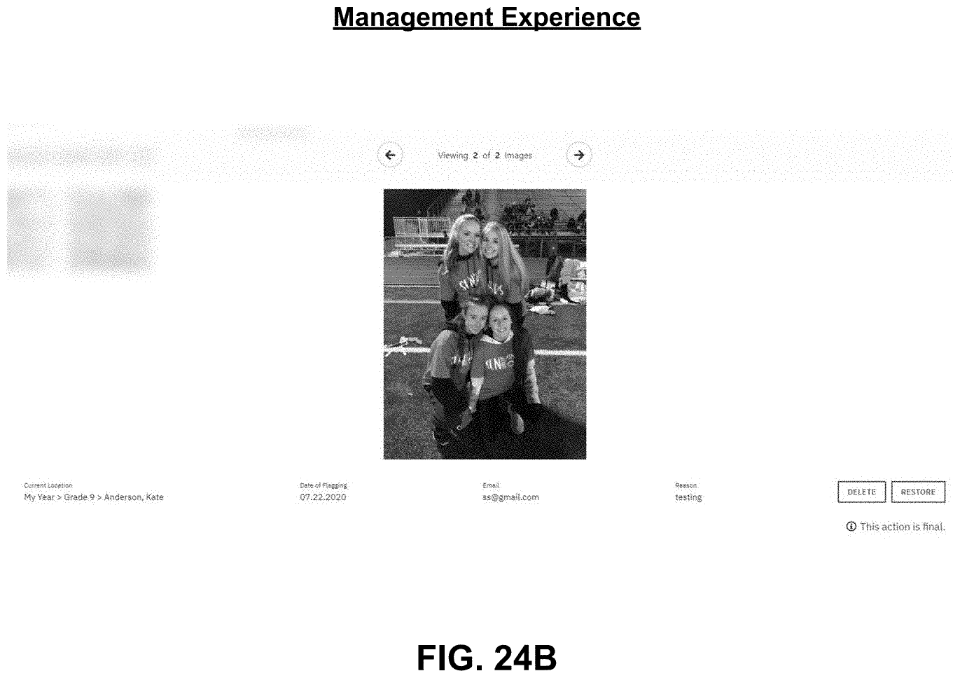

FIGS. 24A and 24B are screenshots of a flagged content interface, wherein an administrator is able to view and work through the flagged content queue (photos that were flagged by users during their explore experience. This interface allows for an administrator to view any flagged content and make a final determination as to whether the content should be deleted (because it violates policies) or should be restored (because it complies with policies).

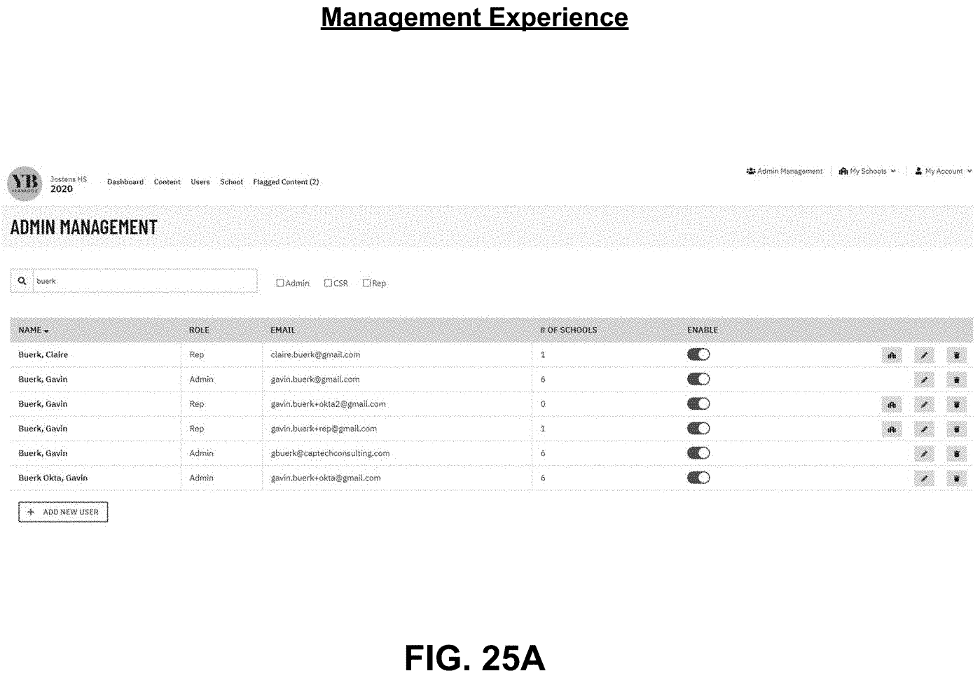

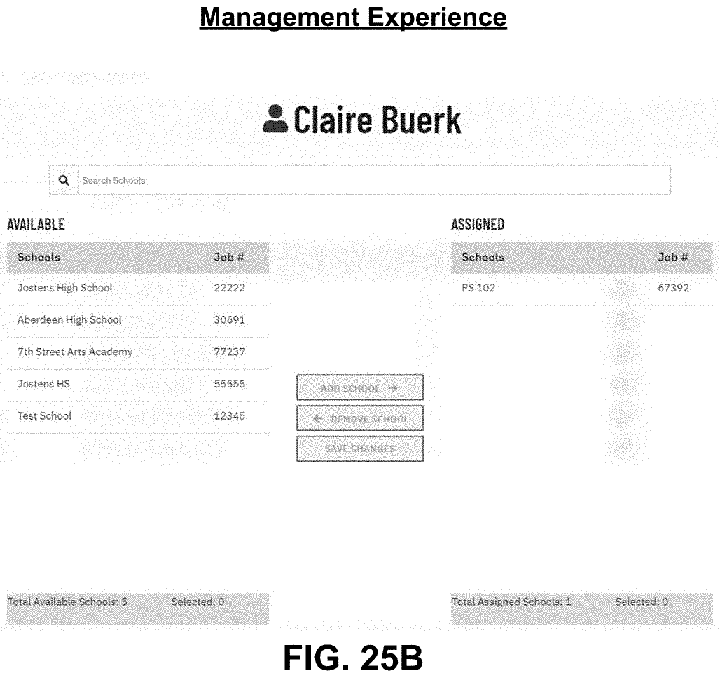

FIGS. 25A and 25B are screenshots of an administrator management interface, in which certain administrators of a given authority are able to add, delete, or update specific administrators of lower authority and to further tie a given user to a specific school. For example, a given representative of a company associated with the yearbook and the yearbook services may have a multitude of schools within their territory.

Accordingly, the interactive yearbook of the present invention provides a user with the advantages associated with each of a printed yearbook and digital yearbook format. More specifically, not only can a user hold a physical book and experience the feel of turning physical pages and seeing printed content, but the user can further access additional digital content that further expands upon related printed content, providing a more enhanced and overall interactive experience for the user. By combining user-contributed digital content and the traditional print yearbook, the present invention provides an interactive and inclusive experience, empowering every student to represent who they are. Allowing for student-selected content provides a customized feel and offers students the opportunity to share their own personal stories and memories via the digital images that they select. Furthermore, the present invention drives coverage within yearbook, as any given student can supplement printed content with additional digital content, thereby expanding the available content. Additionally, the web- and/or cloud-based platform is accessible via a user's personal computing device, such as a smartphone or tablet, and does not require any downloads or specialized hardware to in order to experience the offerings of the interactive yearbook. Additionally, all submitted digital content is moderated to ensure appropriateness and compliance with policies.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system providing for the contribution, management, exploration and consumption of digital content in connection with printed content provided in a physical article, the system comprising:
a server configured to communicate and exchange data with one or more computing devices over a network, the server comprising a hardware processor coupled to non-transitory, computer-readable memory containing instructions executable by the processor to cause the server to:
store, in a database, a plurality of user accounts, each user account comprising user-contributed digital content associated with respective printed content provided in a physical article, the user-contributed digital content having successfully undergone a content moderation process;
receive, from a computing device, a request for access to user-contributed digital content of one of the user accounts, the request comprising image data captured via a camera of the computing device, the image data including one or more unique identifiers associated with printed content in the physical article;
process the request to identify a user account and user-contributed digital content associated with the printed content in the physical article; and
provide the requesting computing device with access to the user-contributed digital content upon a positive identification.

2. The system of claim 1, wherein the physical article comprises a yearbook associated with an educational institution and users comprise at least one of students of the educational institution, friends and/or relatives associated with a student, staff associated with the yearbook and tasked with creation and/or management thereof, and staff or employees of the educational institution.

3. The system of claim 2, wherein the content moderation process comprises at least one of an artificial intelligence (AI)-based content moderation process and a human-based content moderation process.

4. The system of claim 3, wherein each of the AI-based and human-based content moderation processes comprises review of user-contributed digital content and a determination of whether subject matter of the user-contributed digital content complies with policies instituted by the educational institution governing such content.

5. The system of claim 4, wherein user-contributed digital content is deemed to have successfully undergone a content moderation process upon a positive determination that the subject matter of the user-contributed digital content complies with the policies.

6. The system of claim 2, wherein each user account is associated with a respective student of the educational institution.

7. The system of claim 6, wherein, prior to receiving, accepting, and storing user-contributed digital content, the server is configured to initiate at least one of an initial registration process and an authentication process with a given student.

8. The system of claim 7, wherein an initial registration process comprises transmitting, from the server, an invitation to a given student to contribute digital content associated with the yearbook, the invitation prompting the student to confirm acceptance of the invitation.

9. The system of claim 8, wherein the authentication process comprises transmitting a request to the given student to confirm their identity by satisfying at least one of a biometric factor and a challenge-response factor.

10. The system of claim 9, wherein the biometric factor comprises at least one of a fingerprint scan, a retinal scan, a facial scan, voice recognition, and speech recognition and the challenge-response factor comprises at least one of password authentication, passphrase authentication, and email authentication.

11. The system of claim 10, wherein the server is configured to carry out at least one of facial-recognition analysis and keypoint detection analysis to confirm an identity of a given student during an authentication process.

12. The system of claim 2, wherein the printed content comprises at least one of an image and text provided in the yearbook.

13. The system of claim 12, wherein user-contributed digital content comprises at least one of one or more images, one or more video-based files, one or more audio-based files, and text.

14. The system of claim 13, wherein the printed content comprises a portrait photograph of a given student and the corresponding user account for the given student comprises a set of one or more digital photographs contributed by the given student and associated with the portrait photograph in the yearbook.

15. The system of claim 14, wherein the request for access to user-contributed digital content comprises a captured image of a portrait photograph of a student from the yearbook.

16. The system of claim 15, wherein processing of the request comprises performing image analysis on the captured image of the portrait photograph to identify one or more unique identifiers associated with the portrait photograph and further correlating the one or more unique identifiers with identifying data associated with the set of one or more student-contributed digital photographs of the student's account.

17. The system of claim 16, wherein at least one set of one or more student-contributed digital photographs for each student account is tied to a corresponding portrait photograph of that student via a unique identifier.

18. The system of claim 17, wherein the image analysis includes at least one of facial recognition analysis and keypoint detection analysis.

19. The system of claim 18, wherein the one or more unique identifiers comprises one or more keypoints.

20. The system of claim 20, wherein, upon a positive correlation, the server is configured to provide the requesting computing device with access to the set of one or more student-contributed digital photographs.
